(19) United States
(12) Patent Application Publication
(10) Pub. No.: US 2006/0077458 A1
(43) Pub. Date: Apr. 13, 2006

(54) Printing method and printing system

(75) Inventor: Takao Miyazaki, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/245,058

(22) Filed: Oct. 7, 2005

(30) Foreign Application Priority Data
Oct. 7, 2004 (JP) 2004-295358

(51) Int. Cl. G06F 3/12

(52) U.S. Cl. 358/1.15

(57) ABSTRACT

The present invention provides a printing method of printing an image for which a client places a print order by making an image quality correction to an item indicated by the client, comprising the steps of: managing a print history of a client individually for each client, detecting as an image to be repeat-printed based on the print history of an image for which an order for repeat print is placed from among images for which print orders are accepted from clients, and setting an item of image quality correction and an amount of correction based on the print history such that the same image quality correction as the image quality correction made before to the image to be repeat-printed can be made.

### BACKGROUND OF THE INVENTION

1. Field of the Invention

The present invention relates to a printing method and a printing system, and more specifically to a printing method and a printing system which perform image quality correction on an image and then prints the image.

2. Description of the Related Art

Generally, a digital camera records a shot image on a memory card which can be inserted into and removed from a camera body. Therefore, when a shot image is printed, the memory card is removed from the digital camera, and the removed memory card is brought to a photo shop to make an order for print. At this time, when the digital camera has the function of a DPOF (digital print order format), it is possible at the camera side to set the camera to print only necessary images, but a print order using the DPOF requires a laborious operation for settings, and the operation itself is complicated.

Then, there is a system for providing a print acceptance terminal at a shop such as a photo studio, etc. so that a client can use the print acceptance terminal to place an order for the necessary number of images to be printed (for example, Japanese Patent Application Laid-Open No. 2002-123593). In this system, when a memory card is inserted into a card slop made in the print acceptance terminal, an image recorded on the memory card is listed on the monitor so that the client can place a print order of the necessary number of images by selecting necessary images to be printed.

Additionally, some systems have the function of correcting image quality, and a client can perform image quality correction on an image as necessary when placing a print order. However, it is difficult for a beginner to perform the image quality correction with appropriate settings. Therefore, Japanese Patent Application Laid-Open No. 10-191246 proposes obtaining a condition of the optimum image quality correction according to shooting information about an image.

However, the method of Japanese Patent Application Laid-Open No. 10-191246 has the problem that the taste of a client cannot be appropriately reflected.

### SUMMARY OF THE INVENTION

The present invention has been developed to solve the above-mentioned problems, and aims at providing a printing method and a printing system capable of easily printing a client desired image.

To attain the above-described advantage, a first aspect of the present invention provides a printing method of an image for which a client places a print order by making an image quality correction to an item indicated by the client, the method comprising: managing a print history of a client individually for each client; detecting an image for which an order for repeat print is placed as an image to be repeat-printed, from among images for which print orders are accepted from the client, based on the print history; and setting an item of image quality correction and an amount of correction based on the print history such that the same image quality correction as the image quality correction made before to the image to be repeat-printed can be made.

According to the first aspect, the print history of a client is individually managed. When an image to be repeat-printed is included in the images for which a client has placed a print order, an item of image quality correction and an amount of correction are set based on the print history such that the same image quality correction as the image quality correction made before can be made on the image to be repeat-printed. Thus, laborious settings for image quality correction are not required, and an image having the same image quality as the previously printed image can be easily obtained.

To attain the above-described advantage, a second aspect of the present invention provides the printing method according to the first aspect, wherein on an image for which a print order is newly placed, a most frequently used item of image quality correction in items of image quality correction made before by a client who places a print order is detected as a most frequently used image quality correction item from the print history; an image requiring image quality correction of the detected most frequently used image quality correction item is extracted as an image to be corrected from among images for which print orders are newly placed based on the print history; an image most requiring image quality correction is extracted as a target image most requiring correction from among extracted images to be corrected based on the print history; a plurality of sample images are generated by stepwise changing an amount of correction of the extracted target image most requiring correction and making image quality correction to the most frequently used image quality correction item; one of the plurality of generated sample images is selected; and an item of image quality correction to be made to the image to be corrected and an amount of correction are set such that the same image quality correction as the image quality correction made to the selected sample image can be made.

According to the second aspect, based on the print history of a client, client-desired image quality correction can be automatically set for the image for which a print order is newly placed. That is, the most frequently used item of image quality correction in the items of image quality correction made before by a client is first detected as the most frequently used image quality correction item from the print history. Images requiring the image quality correction of the detected most frequently used image quality correction item are extracted based on the print history as images to be corrected from among the images for which print orders are newly placed. From among the extracted images to be corrected, the image most requiring image quality correction is extracted as a target image most requiring correction based on the print history. The image quality correction of the most frequently used image quality correction item is made by stepwise changing the amount of correction to the extracted target image most requiring correction, and a plurality of sample images are generated. One of the plurality of generated sample images is selected, and an item of image quality correction to be made to the image to be corrected and an amount of correction are set such that the same image quality correction as the image quality correction made to the selected sample image can be made. Thus, client-desired image quality correction can be automatically set for an image for which an order is newly placed.

To attain the above-described advantage, a third aspect of the present invention provides the printing method of printing an image for which a client places a print order by making an image quality correction to an item indicated by the client according to the first aspect, wherein a print history of a client is individually managed for each client; a most frequently used item of image quality correction in items of image quality correction made before by a client who places a print order is detected as a most frequently used image quality correction item from the print history; an image requiring image quality correction of the detected most frequently used image quality correction item is extracted as an image to be corrected from among images for which print orders are newly placed based on the print history; an image most requiring image quality correction is extracted as a target image most requiring correction from among extracted images to be corrected based on the print history; a plurality of sample images are generated by stepwise changing an amount of correction of the extracted target image most requiring correction and making image quality correction to the most frequently used image quality correction item; one of the plurality of generated sample images is selected; and an item of image quality correction to be made to the image to be corrected and an amount of correction are set such that the same image quality correction as the image quality correction made to the selected sample image can be made.

According to the third aspect, based on the print history of a client, client-desired image quality correction can be automatically set for the image for which a print order is newly placed. That is, the print history of a client is individually managed for each client, and the most frequently used item of image quality correction in the items of the image quality correction made before by the client is detected from the print history as the most frequently used image quality correction item. Images requiring image quality correction of the detected most frequently used image quality correction item are extracted based on the print history as images to be corrected from among the images for which print orders are newly set. From among the extracted images to be corrected, the image most requiring the image quality correction is extracted as a target image most requiring correction based on the print history. A plurality of sample images are generated by stepwise changing the amount of correction to the extracted target image most requiring correction and performing image quality correction of the most frequently used image quality correction item. One of a plurality of sample images is selected, and an item of image quality correction made to an image to be corrected and an amount of correction are set such that the same image quality correction as the image quality correction made to the selected sample image can be made. Thus, client-desired image quality correction can be automatically set for an image for which an order is newly placed.

To attain the above-mentioned advantage, a fourth aspect of the present invention provides the printing methods of the second or third aspect, wherein the image to be corrected is extracted by detecting an image having the same shooting condition as a prescribed shooting condition of an image to which image quality correction of the most frequently used image quality correction item is made from among images for which print orders are newly placed.

According to the fourth aspect, an image to be corrected is extracted by detecting an image having the same shooting condition as the prescribed shooting condition of an image to which the image quality correction of the most frequently used image quality correction item is made from among the images for which print orders are newly placed. That is, it is assumed that an image having substantially the same shooting condition is processed by the same image quality correction, and an image having the same shooting condition as the prescribed shooting condition of an image to which the image quality correction of the most frequently used image quality correction item is made is extracted as an image to be corrected.

To attain the above-mentioned advantage, a fifth aspect of the present invention provides the printing methods of the second to fourth aspect, wherein the image to be corrected is extracted by detecting an image having a shooting condition most matching a prescribed shooting condition of an image to which image quality correction of the most frequently used image quality correction item is made from among the images to be corrected.

According to the fifth aspect, the target image most requiring correction is extracted by detecting an image having a shooting condition most matching the prescribed shooting condition of an image to which the image quality correction of the most frequently used image quality correction item is made from among the images to be corrected. That is, it is assumed that the image having the shooting condition most similar to the prescribed shooting condition of the image to which the image quality correction of the most frequently used image quality correction item is made most requires correction, and the image is detected from among the images to be corrected.

To attain the above-mentioned advantage, a sixth aspect of the present invention provides the printing methods of the first to fifth aspect, further comprising: accepting an image to be printed from a client; displaying the accepted image on a display device; accepting a print order by selecting the displayed image on the display device; detecting a RAW image from among images which are accepted from the client and are to be printed; developing the detected RAW image in a developing process; assigning a symbol identifying a RAW image; and displaying the RAW image to which the symbol is assigned on the display device.

According to the sixth aspect, if a RAW image is contained in the images which are accepted from a client and are to be printed when images displayed on a display device are to be selected and print-ordered, developed images are displayed on the display device, and the images are assigned symbols identifying RAW images and are displayed on the display device. Thus, whether or not the image to be printed is a RAW image can be immediately grasped.

To attain the above-mentioned advance, a seventh aspect of the present invention provides the printing method of the sixth aspect, wherein when an image for which a client places a print order is a RAW image, the image is developed in a developing process, and then printed.

According to the seventh aspect, when a RAW image is contained in the images to be printed, it can be developed and then printed. Thus, RAW images can also be printed.

To attain the above-mentioned advantage, an eighth aspect of the present invention provides the printing system which makes image quality correction of an item indicated by a client to an image for which a print order is placed from a print acceptance terminal, and prints the image on a printer, the system comprising: a management device which manages a print history of a client individually for each client; a repeat print target image detection device which detects as an image to be repeat-printed based on the print history of an image for which an order for repeat print is placed in images for which print orders are accepted from the client; and an image quality correction setting device which sets an item of image quality correction and an amount of correction based on the print history such that the same image quality correction as the image quality correction made before to the image to be repeat-printed detected by the repeat print target image detection device can be made.

According to the eighth aspect, the print history of a client is individually managed for each client. When an image to be repeat-printed is contained in the images for which print orders are placed by a client, an item of image quality correction and an amount of correction are set based on the print history such that the same image quality correction as the image quality correction made before to the image can be made. Thus, laborious settings for image quality correction are not required, and an image having the same image quality as the previously printed image can be easily obtained.

To attain the above-mentioned advantage, a ninth aspect of the present invention provides the printing system of the eighth aspect, further comprising: a most frequently used image quality correction item detection device which detects a most frequently used item of image quality correction in items of image quality correction made before by a client who places a print order as a most frequently used image quality correction item from the print history; a correction target extraction device which extracts an image requiring image quality correction of the most frequently used image quality correction item detected by the most frequently used image quality correction item detection device as an image to be corrected from among images for which print orders are newly placed based on the print history; a most correction requiring target image extraction device which extracts an image most requiring image quality correction as a target image most requiring correction from among extracted images to be corrected extracted by the correction target extraction device based on the print history; a sample image generation device which generates a plurality of sample images by stepwise changing an amount of correction of the target image most requiring correction extracted by the most correction requiring target image extraction device and makes image quality correction to the most frequently used image quality correction item; a display control device which displays the plurality of sample images generated by the sample image generation device on a display device; and a selection device which selects one of the sample images displayed on the display device, wherein the image quality correction setting device sets an item of image quality correction to be made to the image to be corrected and an amount of correction such that the same image quality correction as the image quality correction made to the sample image selected by the selection device can be made.

According to the ninth aspect, based on the print history of a client, client-desired image quality correction can be automatically set for the image for which a print order is newly placed. That is, the most frequently used item of image quality correction in the items of image quality correction made before by a client is first detected as the most frequently used image quality correction item from the print history. Images requiring the image quality correction of the detected most frequently used image quality correction item are extracted based on the print history as images to be corrected from among the images for which print orders are newly placed. From among the extracted images to be corrected, the image most requiring image quality correction is extracted as a target image most requiring correction based on the print history. The image quality correction of the most frequently used image quality correction item is made by stepwise changing the amount of correction to the extracted target image most requiring correction, and a plurality of sample images are generated. One of the plurality of generated sample images is selected, and an item of image quality correction to be made to the image to be corrected and an amount of correction are set such that the same image quality correction as the image quality correction made to the selected sample image can be made. Thus, client-desired image quality correction can be automatically set for an image for which an order is newly placed.

To attain the above-mentioned advantage, a tenth aspect of the present invention provides a printing system which makes image quality correction of an item indicated by a client to an image for which a print order is placed from a print acceptance terminal, and prints the image on a printer, the system comprising: a management device which manages a print history of a client individually for each client; a most frequently used image quality correction item detection device which detects a most frequently used item of image quality correction in items of image quality correction made before by a client who places a print order as a most frequently used image quality correction item from the print history; a correction target extraction device which extracts an image requiring image quality correction of the most frequently used image quality correction item detected by the most frequently used image quality correction item detection device as an image to be corrected from among images for which print orders are newly placed based on the print history; a most correction requiring target image extraction device which extracts an image most requiring image quality correction as a target image most requiring correction from among extracted images to be corrected by the correction target execution device based on the print history; a sample image generation device which generates a plurality of sample images by stepwise changing an amount of correction of the target image most requiring correction extracted by the most correction requiring target image extraction device and makes image quality correction to the most frequently used image quality correction item; a display control device which displays the plurality of sample images generated by the sample image generation device on a display device; a selection device which selects one of the sample images displayed on the display device; and an image quality correction setting device which sets an item of image quality correction to be made to the image to be corrected and an amount of correction such that the same image quality correction as the image quality correction made to the sample image selected by the selection device can be made.

According to the tenth aspect, based on the print history of a client, client-desired image quality correction can be automatically set for the image for which a print order is newly placed. That is, the print history of a client is individually managed for each client, and the most frequently used item of image quality correction in the items of image quality correction made before by a client is first detected as the most frequently used image quality correction item from the print history. Images requiring the image quality correction of the detected most frequently used image quality correction item are extracted based on the print history as images to be corrected from among the images for which print orders are newly placed. From among the extracted images to be corrected, the image most requiring image quality correction is extracted as a target image most requiring correction based on the print history. The image quality correction of the most frequently used image quality correction item is made by stepwise changing the amount of correction to the extracted target image most requiring correction, and a plurality of sample images are generated. One of the plurality of generated sample images is selected, and an item of image quality correction to be made to the image to be corrected and an amount of correction are set such that the same image quality correction as the image quality correction made to the selected sample image can be made. Thus, client-desired image quality correction can be automatically set for an image for which an order is newly placed.

To attain the above-mentioned advantage, an eleventh aspect of the present invention provides the printing systems of the ninth or tenth aspect, wherein the correction target image extraction device extracts the image to be corrected by detecting an image having the same shooting condition as a prescribed shooting condition of an image to which image quality correction of the most frequently used image quality correction item is made from among images for which print orders are newly placed.

According to the eleventh aspect, an image to be corrected is extracted by detecting an image having the same shooting condition as the prescribed shooting condition of an image to which the image quality correction of the most frequently used image quality correction item is made from among the images for which print orders are newly placed. That is, it is assumed that an image having substantially the same shooting condition is processed by the same image quality correction, and an image having the same shooting condition as the prescribed shooting condition of an image to which the image quality correction of the most frequently used image quality correction item is made is extracted as an image to be corrected.

To attain the above-mentioned advantage, a twelfth aspect of the present invention provides the printing systems of the ninth to eleventh aspect, wherein the most correction requiring target image extraction device extracts the image to be corrected by detecting an image having a shooting condition most matching a prescribed shooting condition of an image to which image quality correction of the most frequently used image quality correction item is made from among the images to be corrected.

According to the twelfth aspect, the target image most requiring correction is extracted by detecting an image having a shooting condition most matching the prescribed shooting condition of an image to which the image quality correction of the most frequently used image quality correction item is made from among the images to be corrected. That is, it is assumed that the image having the shooting condition most similar to the prescribed shooting condition of the image to which the image quality correction of the most frequently used image quality correction item is made most requires correction, and the image is detected from among the images to be corrected.

To attain the above-mentioned advantage, a thirteenth aspect of the present invention provides the printing systems of the ninth to twelfth aspect, further comprising: an accepting device which accepts an image to be printed from a client and makes the accepted image to be displayed on a display device; a selection device which selects the displayed image displayed on the display device and places a print order; a RAW image detection device which detects a RAW image from among images which are accepted from a client and are to be printed; and a developing device which develops a RAW image, wherein the RAW image detected by the RAW image detection device is developed by the developing device, assigned a symbol identifying a RAW image, and displayed on the display device.

According to the thirteenth aspect, if a RAW image is contained in the images which are accepted from a client and are to be printed when images displayed on a display device are to be selected and print-ordered, developed images are displayed on the display device, and the images are assigned symbols identifying RAW images and are displayed on the display device. Thus, whether or not the image to be printed is a RAW image can be immediately grasped.

To attain the above-mentioned advantage, a fourteenth aspect of the present invention provides the printing system of the thirteenth aspect, wherein when an image for which a client places a print order is a RAW image, the developing device performs a developing process on the image, and then prints the image.

According to the fourteenth aspect, when a RAW image is contained in the images to be printed, it can be developed and then printed. Thus, RAW images can also be printed.

To attain the above-mentioned advantage, a fifteenth aspect of the present invention provides the printing systems of the eighth to fourteenth aspect, wherein each print acceptance terminal is connected such that the terminal can communicate with a management server, and the management server comprises the management device, and centrally manages the print history.

According to the fifteenth aspect, when there are a plurality of print acceptance terminals, each print acceptance terminal is connected to a management server such that communications can be performed between the print acceptance terminal and the management server, and the management server centrally manages the print history.

As described above, according to the printing method and the printing system of the present invention, image quality correction can be made to an image with the desire of a client reflected.

### BRIEF DESCRIPTION OF THE DRAWINGS

FIG. 1 shows the configuration of the system showing an embodiment of the printing system according to the present invention;

FIG. 2 is a front view showing the configuration of the print acceptance terminal;

FIG. 3 is a front view showing the electrical configuration of the print acceptance terminal;

FIG. 4 shows an example of a management file;

FIG. 5 is a flowchart of the procedure of the processing operation of the print acceptance terminal when a print order is placed;

FIG. 6 shows an example of an input screen of an ID and a password;

FIG. 7 is a flowchart of the procedure of the processing operation of the print acceptance terminal when a print order is placed (continued from FIG. 5);

FIG. 8 shows an example of display of the print order acceptance screen;

FIG. 9 shows an example of the display of the basic screen of image quality correction;

FIG. 10 shows an example of display of variation images for camera shake correction;

FIG. 11 shows an example of display of variation images for color correction;

FIG. 12 shows an example of display of variation images for brightness/contrast correction;

FIG. 13 is a flowchart of the procedure of the processing operation of the print acceptance terminal when a print order is placed (continued from FIG. 5);

FIG. 14 shows a statistical result of image quality correction;

FIG. 15 shows a statistical result of the shooting condition of an image processed by image quality correction;

FIG. 16 shows a statistical result of the shooting condition of an image processed by camera shake correction;

FIG. 17 shows a statistical result of the shooting condition of an image processed by color correction;

FIG. 18 shows an example of display of the screen of image quality correction for the target image most requiring correction;

FIG. 19 shows an example of display of the screen of image quality correction for an image to be corrected;

FIG. 20 is a flowchart of the procedure of the processing operation of the print acceptance terminal when a print order is placed (continued from FIG. 13);

FIG. 21 is a flowchart of the procedure of the processing operation of the print acceptance terminal when a print order is placed (continued from FIG. 5);

FIG. 22 shows an example of display of the screen of image quality correction for a repeat print image;

FIG. 23 is a flowchart of the procedure of the processing operation of the print acceptance terminal when a print order is placed (continued from FIG. 21);

FIG. 24 is a flowchart of the procedure of the processing operation of the print acceptance terminal when a print order is placed (continued from FIG. 23);

FIG. 25 is a flowchart of the procedure of the processing operation of a print acceptance terminal when a print order for images is placed including a RAW image;

FIG. 26 is a flowchart of the procedure of the processing operation of a print acceptance terminal when a print order for images is placed including a RAW image (continued from FIG. 25);

FIG. 27 shows an example of display of a starting screen of the developing process of a RAW image;

FIG. 28 shows an example of display of a screen of the developing process of a RAW image; and

FIG. 29 shows an example of display of an acceptance screen of a print order of an image including a RAW image.

### DETAILED DESCRIPTION OF THE PREFERRED EMBODIMENTS

The best modes for embodying the printing method and the printing system according to the present invention are explained below by referring to the attached drawings.

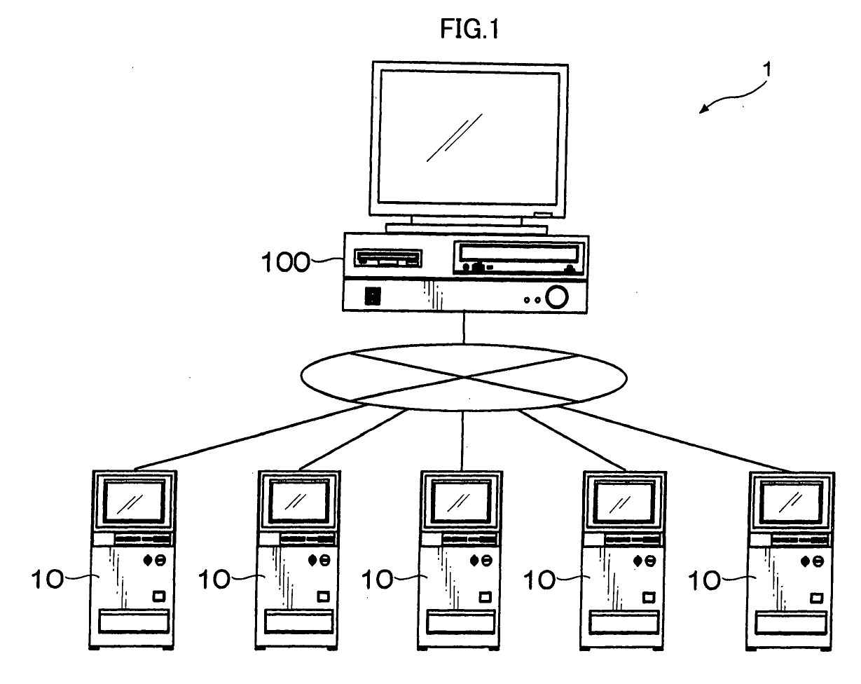

FIG. 1 shows the configuration of the system showing an embodiment of the printing system according to the present invention. As shown in FIG. 1, a printing system 1 according to the present embodiment is configured by a plurality of print acceptance terminals 10 and a management server 100. The plurality of print acceptance terminals 10 are connected to the management server 100 over a network such that communication can be performed.

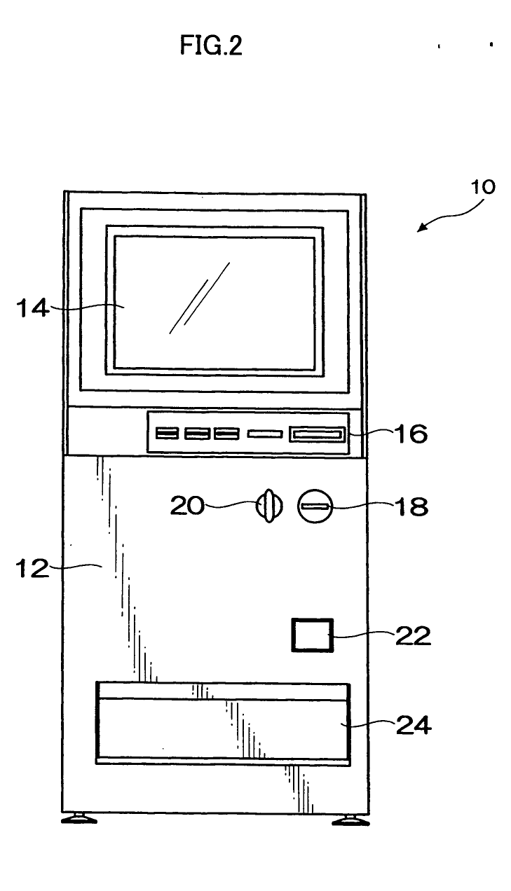

FIG. 2 is a front view showing the configuration of the print acceptance terminal 10. As shown in FIG. 2, the print acceptance terminal 10 has a device body 12 having the form of a box, and has a display 14 provided with a touch panel, a medium slot 16 for insertion of various storage media such as a memory card, etc., a coin slot 18 for deposit of a use rate, a return lever 20 for refund of deposited use rate, a coin return 22 for taking out refunded coin, a print ejector 24 for taking out generated print, etc. in front.

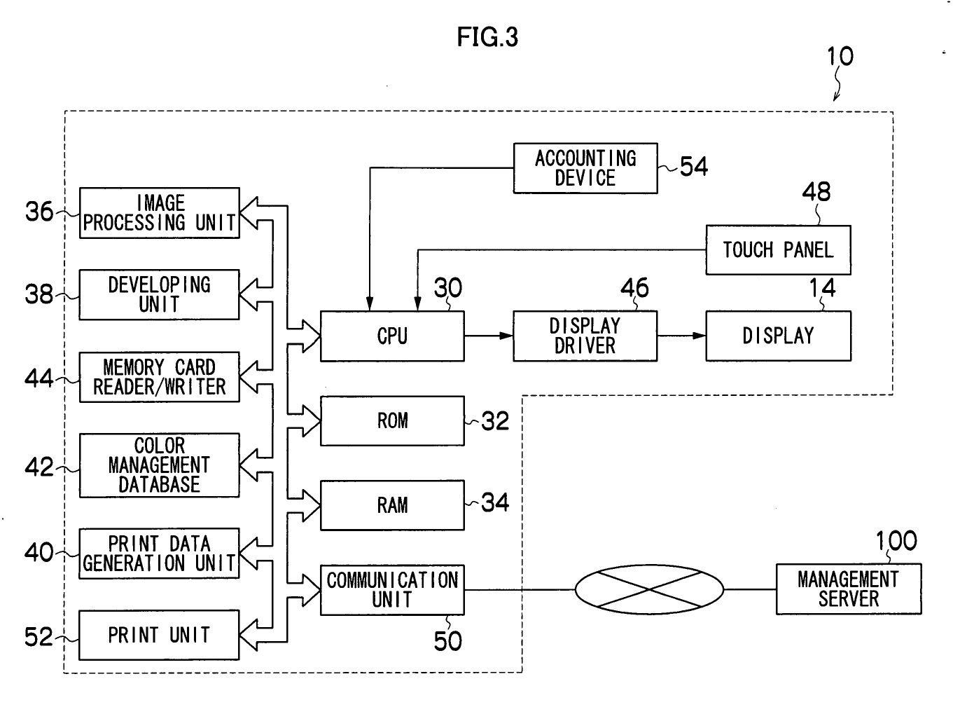

FIG. 3 is a block diagram of the electrical configuration of the print acceptance terminal 10. As shown in FIG. 3, the print acceptance terminal 10 is configured by a CPU 30, ROM 32, RAM 34, an image processing unit 36, a developing unit 38, a print data generation unit 40, a color management database 42, a memory card reader/writer 44, a display driver 46, the display 14, a touch panel 48, a communication unit 50, a print unit 52, an accounting device 54, etc.

The CPU 30 functions as a control unit for integrally controlling the entire operation of the print acceptance terminal 10, and controls each unit of the print acceptance terminal 10 while using the RAM 34 as a work area based on the control program stored in the ROM 32. In addition to the control program, ROM 32 stores necessary data for the control.

The image processing unit 36 performs processing such as image quality correction, etc. of an image to be printed under the control of the CPU 30.

The developing unit 38 performs a developing process on RAW image data (raw digital image data obtained by performing at least A/D conversion on a video signal output from an image processing device of an electronic camera) to be printed under the control of the CPU 30.

The print data generation unit 40 generates print data of an image to be printed under the control of the CPU 30.

The color management database 42 stores data for use in correcting the difference in color between the image displayed on the display 14 and the image printed on the print unit 52, and regenerating the same color.

The memory card reader/writer 44 performs the process of reading and writing image data from the memory card inserted into the medium slot 16 under the control of the CPU 30.

The display driver 46 controls the display of the display 14 under the control of the CPU 30.

The touch panel 48 is provided on the display screen of the display 14, detects the coordinate data of the position pressed by a user (client), and outputs the data to the CPU 30.

The communication unit 50 communicates data with the management server 100 connected over a network under the control of the CPU 30.

The print unit 52 prints the print data of the image generated by the print data generation unit 40 on photographic paper under the control of the CPU 30.

The accounting device 54 detects the coin deposited through the coin slot 18, and outputs the deposit information to the CPU 30.

The management server 100 comprises a computer in which a network OS and other server application software are installed, communicates data with each print acceptance terminal 10, and manages the print history of a client. The print history of a client is managed by generating a management file for each client, an ID and a password are set for each client in each management file, and the file is stored in a predetermined storage area (for example, an HDD).

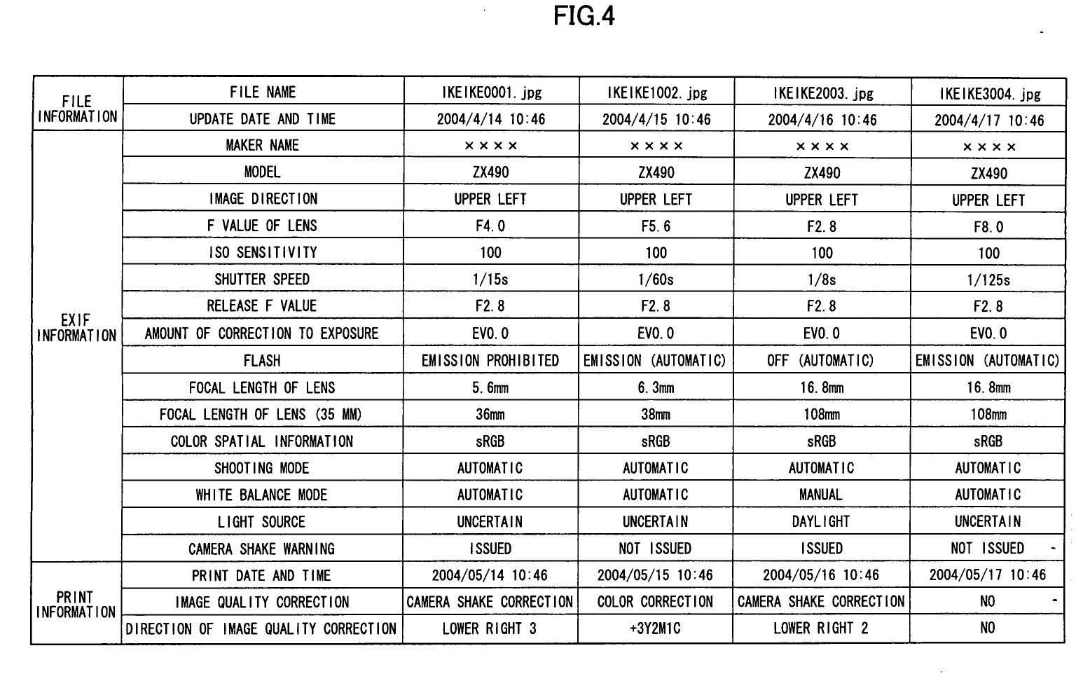

FIG. 4 shows an example of a management file. As shown in FIG. 4, a management file is generated by recording file information, Exif information, and print information for each image printed by a client.

The file information is the information for identification of each image printed by a client. A file name and an update date and time (date and time on which an image is generated (date and time of image quality correction if a client makes image quality correction after shooting the image, and otherwise date of picture-taking is an update date and time)) are recorded in the file information.

Exif information is shooting information about an image printed by a client, and the tag information about Exif added to the image file is recorded as it is.

Print information is setting information when printing an image. In addition to the printing date and time, an item of image quality correction made to an image, and the correction direction are recorded in the information.

The printing system 1 according to an embodiment of the present invention makes image quality correction to an image to be printed by referring to the management file of the print history, and performs a printing process.

Described below is the flow of a series of processes from a print order to print output on the printing system 1 according to an embodiment of the present invention.

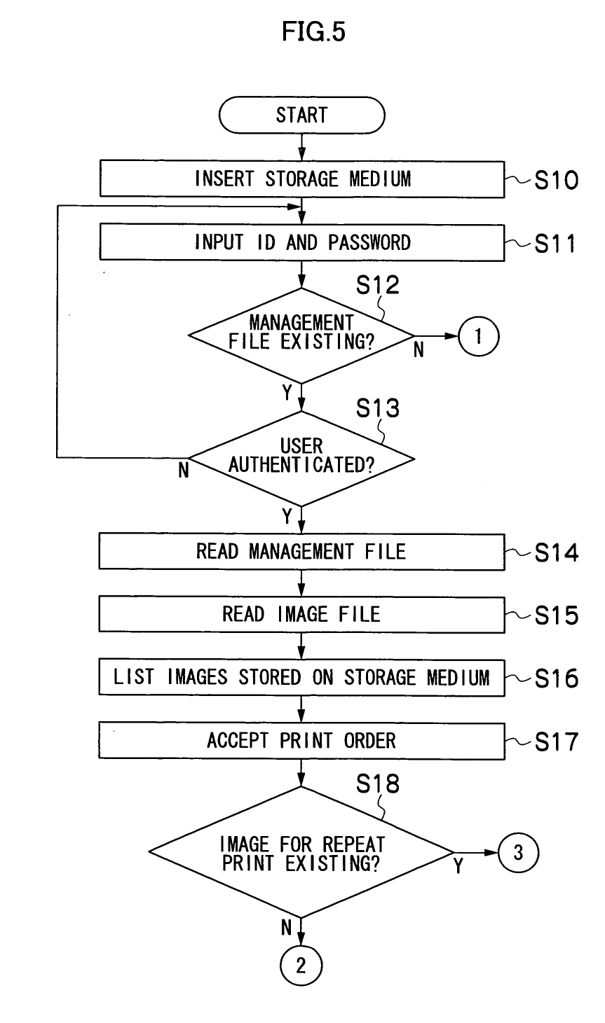

FIG. 5 is a flowchart of the procedure of the processing operation of the print acceptance terminal 10 performed when a print order is placed.

First, a user inserts a storage medium such as a memory card, etc. on which image data is recorded into the medium slot 16 (step S10), and allows the print acceptance terminal 10 to start the process of placing a print order.

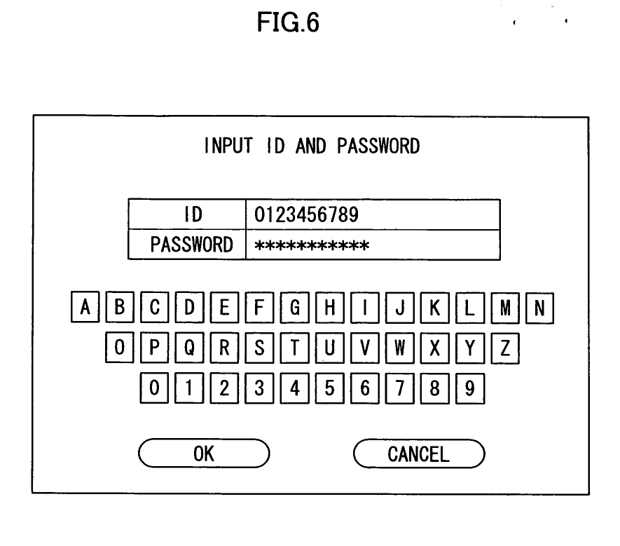

When an order process is started, an input screen of an ID and a password is displayed on the display 14. FIG. 6 shows an example of an input screen of an ID and a password, and a client inputs an ID and a password according to the display on the display 14 (step S11). An ID and a password can be formed by, for example, numbers, alphabetical characters, or a combination of them, and the numbers or alphabetical characters can be input by a touch of them displayed on the display 14.

When an ID and a password are input, the print acceptance terminal 10 accesses the management server 100, and asks the management server 100 whether or not there is a management file corresponding to the input ID.

The management server 100 retrieves a management file corresponding to the ID input by a client from a predetermined storage area according to the information about the ID and the password transmitted from the print acceptance terminal 10, thereby determining the presence/absence of a management file (step S12).

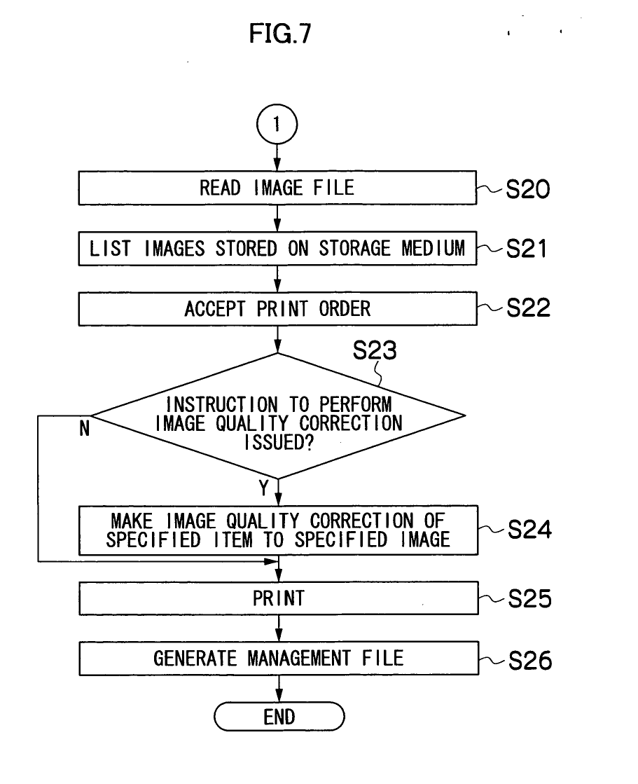

If it is determined that there is no management file, control is passed to step S20 in the flowchart shown in FIG. 7.

First, the print acceptance terminal 10 reads an image file recorded on a storage medium from the storage medium inserted into the medium slot 16 (step S20). Then, it lists thumbnail images of an image indicated by the read image file on the display 14 (step S21), and accepts a print order (step S22).

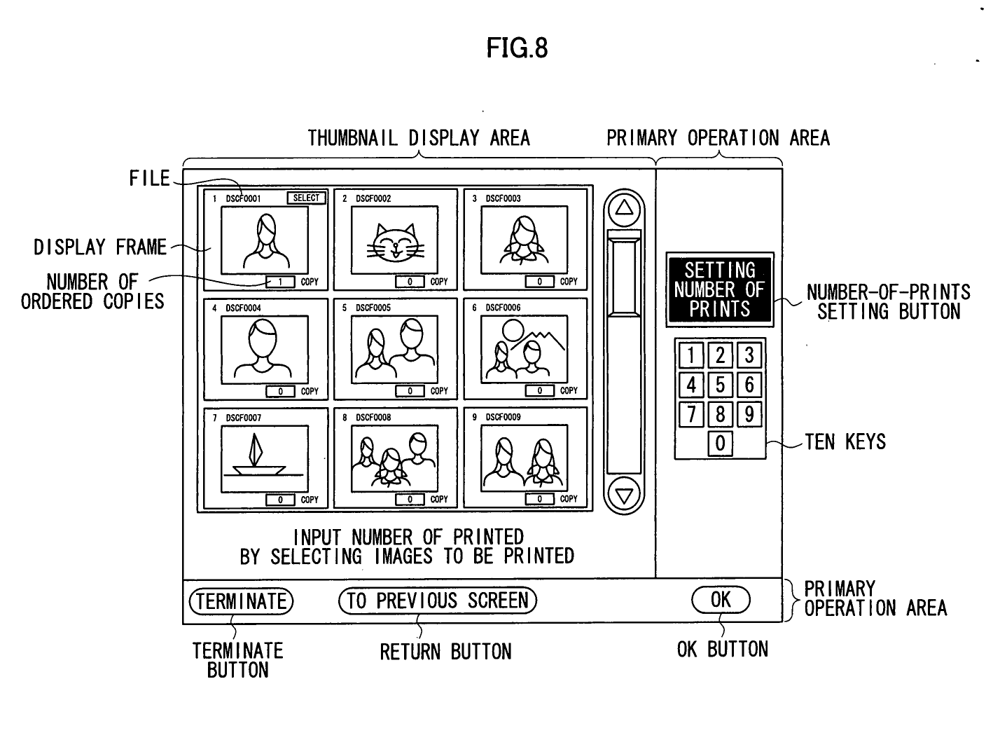

FIG. 8 shows an example of display on the acceptance screen of a print order. As shown in FIG. 8, the display screen on the display 14 is formed mainly by a thumbnail display area, a primary operation area, and a secondary operation area. In the thumbnail display area, an image of the image file read from the storage medium is listed by the thumbnail images. Assuming that nine (3×3) images are simultaneously displayed in the order of file name. When other images are displayed, an up-scroll button or a down-scroll button is touched to scroll the display. Each of the thumbnail images is displayed in each display frame. In the display frame, the file name (displayed at the upper left of each thumbnail image) of the thumbnail image, the number of ordered prints (displayed at the lower right of the thumbnail image), etc. are displayed together. In the primary operation area, ten keys for input of the number of prints are displayed. In the secondary operation area, a button (OK button) for directing determination of a process, a button (return button) for directing return to the previous process screen, a button (terminate button) for directing termination, etc. are displayed.

A user inputs a print order according to the display of the acceptance screen of a print order displayed on the display 14.

First, the thumbnail image of the image for which a print order is placed is touched to select the image for which a print order is placed. When a thumbnail image is touched, the color of the display frame of the touched thumbnail image is changed, and the selected image is discriminated from the other images. In the example shown in FIG. 8, the image positioned at the upper left on the screen (file name: DSCF0001) is selected.

As described above, after the image for which a print order is placed is touched and selected, the ten keys are touched to input the number of prints to be ordered. After the total number of images to be printed is input, the user touches the OK button displayed in the secondary operation area, thereby determining the order.

When the settings of the print order are completed, the display on the display 14 is switched from the screen of the print order to the basic screen for image quality correction.

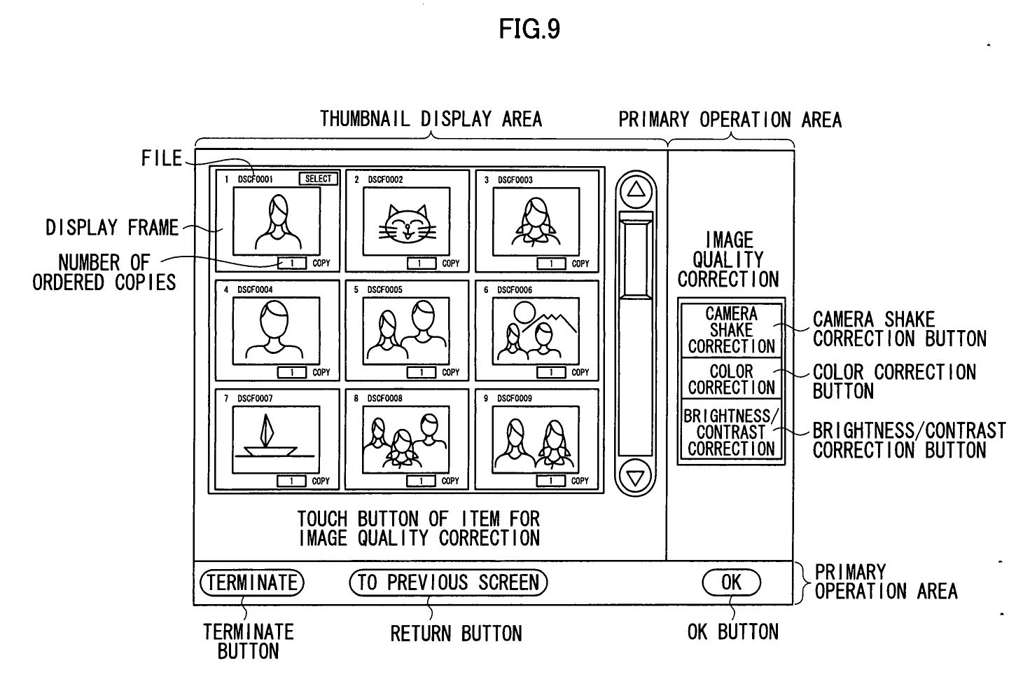

FIG. 9 shows an example of the display of the basic screen for image quality correction. As shown in FIG. 9, the basic screen for image quality correction is formed mainly by a thumbnail display area, a primary operation area, and a secondary operation area. Except the primary operation area, the screen is the same as the print order acceptance screen.

An item of possible image quality correction button is displayed in the primary operation area. In this area, possible image quality correction items can be a camera shake correction button for camera shake correction, a color correction button for color correction, and a brightness/contrast correction execution button for brightness/contrast correction.

When image quality correction is made, a user touches a button for image quality correction to be made. For example, when camera shake correction is to be made, the camera shake correction button is touched, and when color correction is to be made, the color correction button is touched.

Explained first is the case where camera shake correction is to be made. When camera shake correction is made, the camera shake correction button displayed in the operation area is touched. When the camera shake correction button is touched, the print acceptance terminal 10 enters a camera shake correction mode and a correction target selection wait state. In this state, a user touches a thumbnail image of the image to which camera shake correction is to be made, thereby selecting the image to which camera shake correction is to be made.

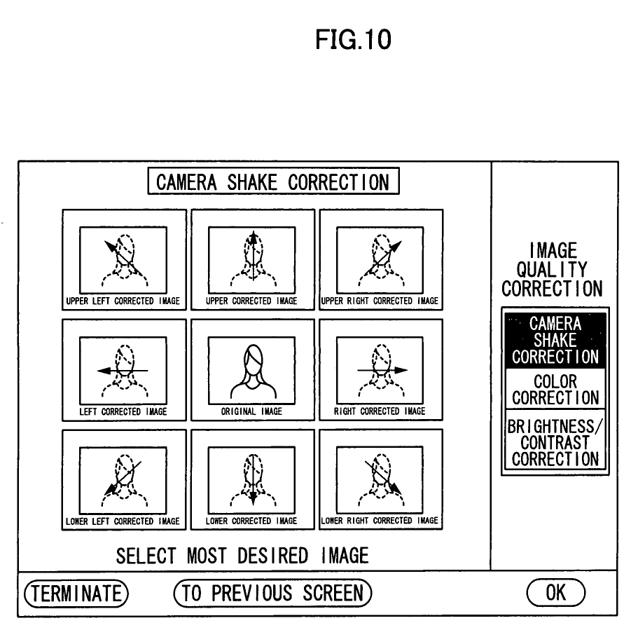

When an image to be corrected is selected, the print acceptance terminal 10 generates variation images for camera shake correction to be made on the selected image, and displays the variation images on the display 14 as shown in FIG. 10.

The variation images for camera shake correction are generated as a total of eight images including an image obtained above the original image by making camera shake correction, an image obtained to the upper right of the original image by making camera shake correction, an image obtained to the right of the original image by making camera shake correction, an image obtained to the lower right of the original image by making camera shake correction, an image obtained below the original image by making camera shake correction, an image obtained to the lower left of the original image by making camera shake correction, an image obtained to the left of the original image by making camera shake correction, and an image obtained to the upper left of the original image by making camera shake correction. Thus, with the original image at the center, the corrected images are arranged and displayed in the respective positions in the thumbnail display area surrounding the original image. Since the method of correcting camera shake is a well-known technology, the explanation of the practical correcting method is omitted here.

A user touches and selects the most desired thumbnail image from among the displayed variation images (including the original image). The print acceptance terminal 10 makes camera shake correction to the original image by an amount of correction made to the selected thumbnail image, thereby terminating the process on the image. If camera shake correction is continued on the image, an instruction to make similar camera shake correction is issued.

Described below is a case where color correction is made. When color correction is made, a color correction button displayed in the operation area is touched. When the color correction button is touched, the print acceptance terminal 10 enters color correction mode and a correction target selection wait state. In this state, a user touches a thumbnail image of the image to which color correction is to be made, thereby selecting the image to which color correction is to be made.

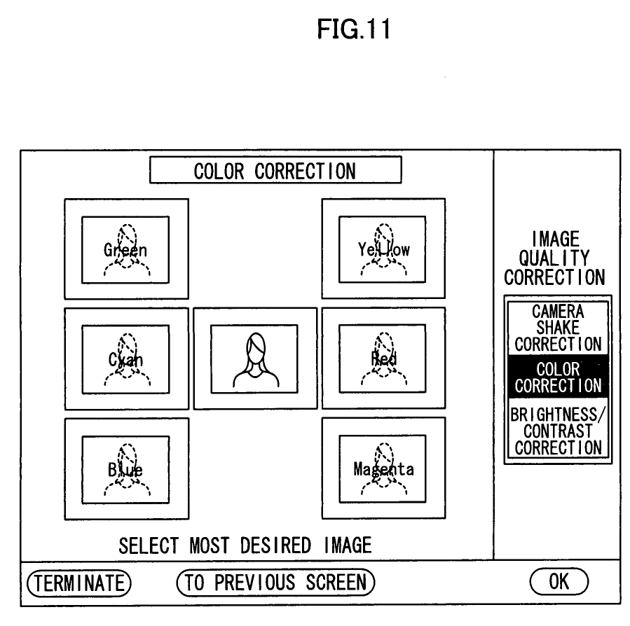

When an image to be corrected is selected, the print acceptance terminal 10 generates variation images for color correction to be made on the selected image, and displays the variation images on the display 14 as shown in FIG. 11.

The variation images for color correction are generated as a total of six images including an image obtained by adding yellow to the original image as a result of making color correction, an image obtained by adding red to the original image as a result of making color correction, an image obtained by adding magenta to the original image as a result of making color correction, an image obtained by adding blue to the original image as a result of making color correction, an image obtained by adding cyan to the original image as a result of making color correction, and an image obtained by adding green to the original image as a result of making color correction. Thus, with the original image at the center, the corrected images are arranged and displayed in series in the respective positions in the thumbnail display area. Since the method of correcting color is a well-known technology, the explanation of the practical correcting method is omitted here.

A user touches and selects the most desired thumbnail image from among the displayed variation images (including the original image). The print acceptance terminal 10 makes color correction to the original image by an amount of correction made to the selected thumbnail image, thereby terminating the process on the image. If color correction is continued on the image, an instruction to make similar color correction is issued.

Next described below is a case where brightness/contrast correction is made. When brightness/contrast correction is made, a brightness/contrast correction button displayed in the operation area is touched. When the brightness/contrast correction button is touched, the print acceptance terminal 10 enters brightness/contrast correction mode and a correction target selection wait state. In this state, a user touches a thumbnail image of the image to which brightness/contrast correction is to be made, thereby selecting the image to which brightness/contrast correction is to be made.

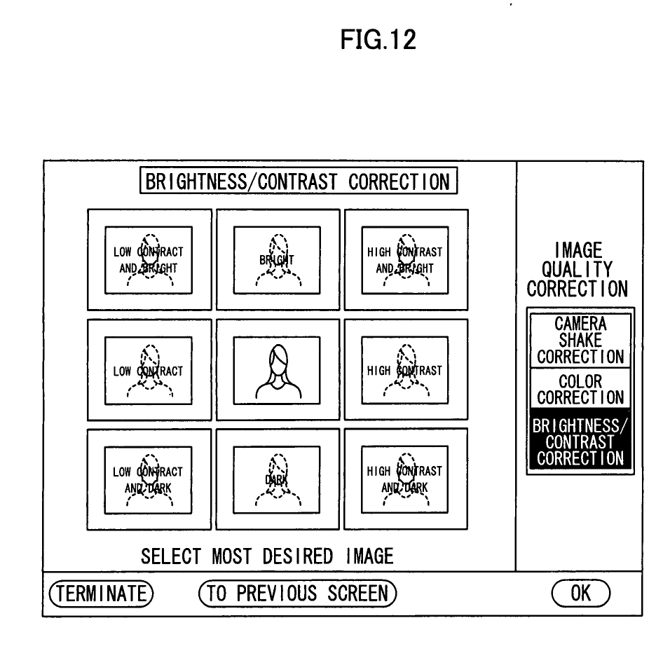

When an image to be corrected is selected, the print acceptance terminal 10 generates variation images for brightness/contrast correction to be made on the selected image, and displays the variation images on the display 14 as shown in FIG. 12.

The variation images for brightness/contrast correction are generated as a total of eight images including an image obtained by simply adding brightness to the original image as a result of making correction, an image obtained by adding brightness and high contrast to the original image as a result of making correction, an image obtained by simply adding high contrast to the original image as a result of making correction, an image obtained by adding darkness and high contrast to the original image as a result of making correction, an image obtained by only adding darkness to the original image as a result of making correction, an image obtained by adding darkness and low contract to the original image as a result of making correction, an image obtained by simply adding low contract to the original image as a result of making correction, and an image obtained by adding brightness and low contract to the original image as a result of making correction. Thus, with the original image at the center, the corrected images are arranged and displayed as surrounding the original image in the respective positions in the thumbnail display area. Since the method of correcting brightness/contrast is a well-known technology, the explanation of the practical correcting method is omitted here.

A user touches and selects the most desired thumbnail image from among the displayed variation images (including the original image). The print acceptance terminal 10 makes brightness/contrast correction to the original image by an amount of correction made to the selected thumbnail image, thereby terminating the process on the image. If brightness/contrast correction is continued on the image, an instruction to make similar brightness/contrast correction is issued.

As described above, when a user makes image quality correction, the user selects an item of image quality correction to be made, selects an image to be corrected, and performs a process of image quality correction. When the image quality correction is completed on the image requiring the image quality correction, the user touches the OK button displayed in the secondary operation area, and the correcting process terminates. When the process of image quality correction is not performed, the user touches the OK button displayed in the secondary operation area, thereby terminating the correcting process.

The print acceptance terminal 10 determines the presence/absence of an instruction to make image quality correction (step S23). If it is issued, the image quality correction is made in the above-mentioned procedure (step S24). When the image quality correction is completed, the print acceptance terminal 10 generates print data of the image for which a print order is placed, thereby performing a printing process (step S25). That is, the print data generation unit 40 generates print data based on the image data (corrected image data if the image quality of the image is corrected) of the image for which a print order is placed, and the generated print data is added to the print unit 52 and printed on photographic paper.

The generated photographic print is ejected to the print ejector 24, and the user receives the photographic print ejected to the print ejector 24.

On the other hand, after terminating the printing process, the print acceptance terminal 10 transmits the user order data (necessary data for generation of a management file of a print history such as the file name of an image for which a print order is placed, Exif information, the contents of image quality correction, etc.) to the management server 100 over a network. The management server 100 generates a management file of a print history based on the order data transmitted from the print acceptance terminal 10 (step S26).

In the present example, since the user is a new client in this example, an ID and a password are set in this step. The ID is automatically set according to a predetermined rule, and the password is set by the user.

As explained above, when a new user has no management file in the management server 100, the user manually makes settings for image quality correction as necessary, and performs a printing process.

When a user has a management file in the management server 100, that is, when it is determined in step S12 in the flowchart shown in FIG. 5 that there is a management file, the process is performed as follows.

If it is determined in step S12 in the flowchart shown in FIG. 5 that there is a management file, an authenticating process is performed on the input password (step S13). That is, it is determined whether or not the input password matches the password set in the corresponding management file, and the user can be authenticated.

If the passwords do not match each other, control is returned to S11, and an ID and a password are input again.

If the passwords match each other, and the user can be successfully authenticated, the print acceptance terminal 10 reads the corresponding management file from the management server 100 (step S14), and reads an image file recorded on the storage medium from the storage medium inserted into the medium slot 16 (step S15). Then, the thumbnail images indicated by the read image file are listed on the display 14 (step S16), and a print order is accepted (step S17).

The display on the display unit is basically the same as the display presented when there is no management file as described above. That is, as shown in FIG. 8, the display is formed mainly by the thumbnail display area, the primary operation area, and the secondary operation area. In the thumbnail display area, an image in a storage medium is displayed as a list of thumbnail images. The user inputs a print order according to the display of the acceptance screen of the print order displayed on the display 14. The input is performed by touching a thumbnail image of the image for which a print order is placed as described above, thereby selecting an image for a print order, and inputting the number of ordered prints by touching the ten keys.

When the input of the number of all images to be printed is completed, the user touches the OK button displayed in the secondary operation area, and determines the order.

When a print order is completely set, the print acceptance terminal 10 determines the presence/absence of an image to be repeat-printed (repeat order) in the images for which print orders are placed (step S118). The determination is made based on the print history of the user obtained from the management server 100. That is, an image having the matching file name and the update date and time with the image for which a print order is placed is detected from the print history, and the presence/absence of the image for repeat print is determined.

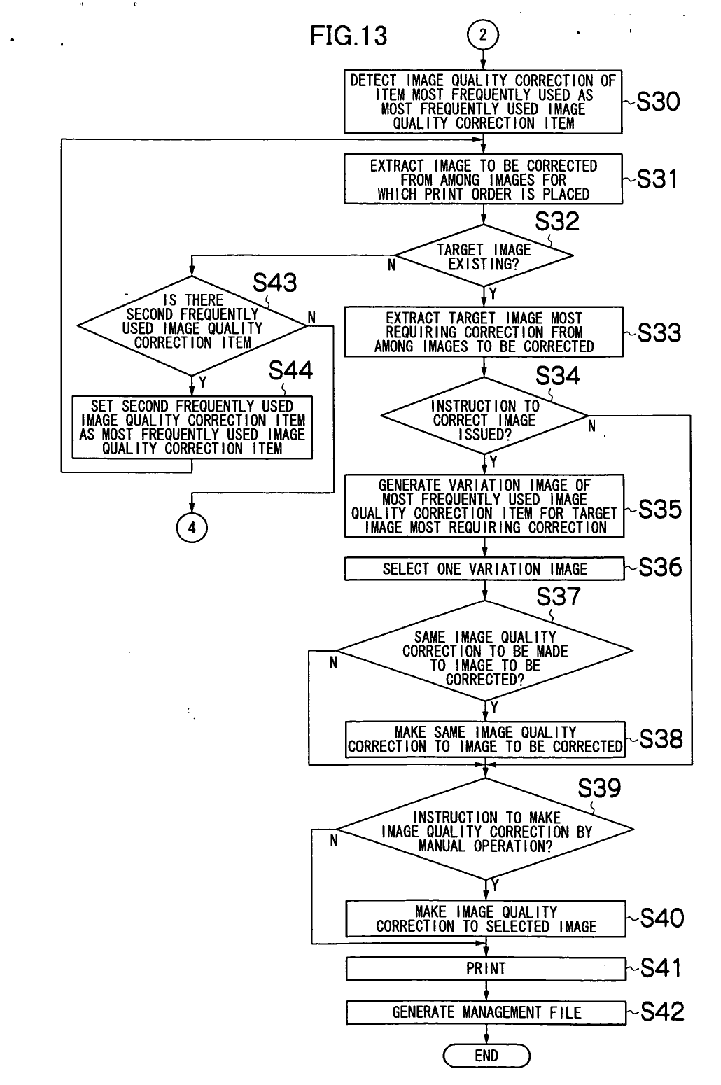

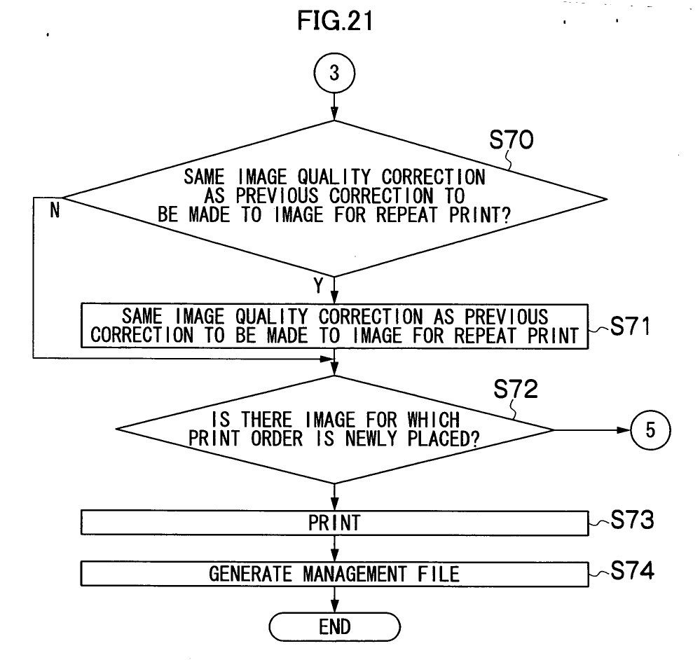

If there is no image for repeat print as a result of the determination, control is passed to step S30 in the flowchart shown in FIG. 13. If there is an image for repeat print, control is passed to step S70 in the flowchart shown in FIG. 21.

First, the process of the case where there is no image for repeat print is explained below. As described above, when there is no image for repeat print, control is passed to step S30 in the flowchart shown in FIG. 13.

First, the print acceptance terminal 10 detects the most frequently used image quality correction item based on the print history obtained from the management server 100 (step S30).

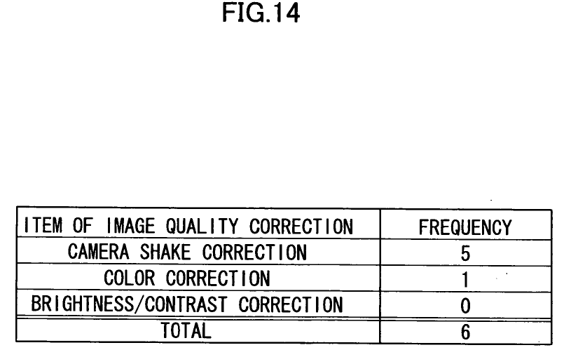

The most frequently used image quality correction item refers to the most frequently used item of image quality correction ever made by the user, and is detected based on the statistical result on the print history. For example, as shown in FIG. 14, if the user made image quality correction six times, that is, five times for camera shake correction, one time for color correction, and zero for brightness/contrast correction, then the camera shake correction is the most frequently used image quality correction item.

Next, the print acceptance terminal 10 extracts an image to be corrected from among the images for which print orders are placed (step S31). The image to be corrected detected and extracted as an image having a shooting condition similar to the shooting condition of the image to which the image quality correction of the most frequently used image quality correction item is made from among the images for which print orders are placed. For more detail, the process is performed as follows.

First, the image to which the image quality correction of the most frequently used image quality correction item is made is extracted from the images ever printed based on the print history.

Next, the information about a predetermined shooting condition is obtained from the information about the shooting condition of the extracted image. Assuming that the predetermined shooting condition is set for each item of image quality correction, for example, a camera shake warning, a flash, a shutter speed (priorities are assigned to (1) camera shake warning, (2) flash, and (3) shutter speed in this order) are set for camera shake correction, and a white balance is set for color correction.

Next, the most frequently used shooting condition is detected from the information about the obtained and predetermined shooting condition. That is, for example, when the most frequently used image quality correction item is camera shake correction, a predetermined shooting condition is camera shake warning (highest priority). Therefore, the most frequently used shooting condition is detected in the camera shake warnings. If the most frequently used image quality correction item is color correction, a predetermined shooting condition is white balance. Therefore, the most frequently used shooting condition is detected in the white balances.

In the case of a camera shake warning, two shooting conditions are indicated, that is, “camera shake warning issued” or “camera shake warning not issued”. Therefore, whichever having a higher frequency is detected as a most frequently used shooting condition.

In the case of a white balance, two shooting conditions are indicated, that is, “automatic balance” or “manual balance”. Therefore, whichever having a higher frequency is detected as a most frequently used shooting condition.

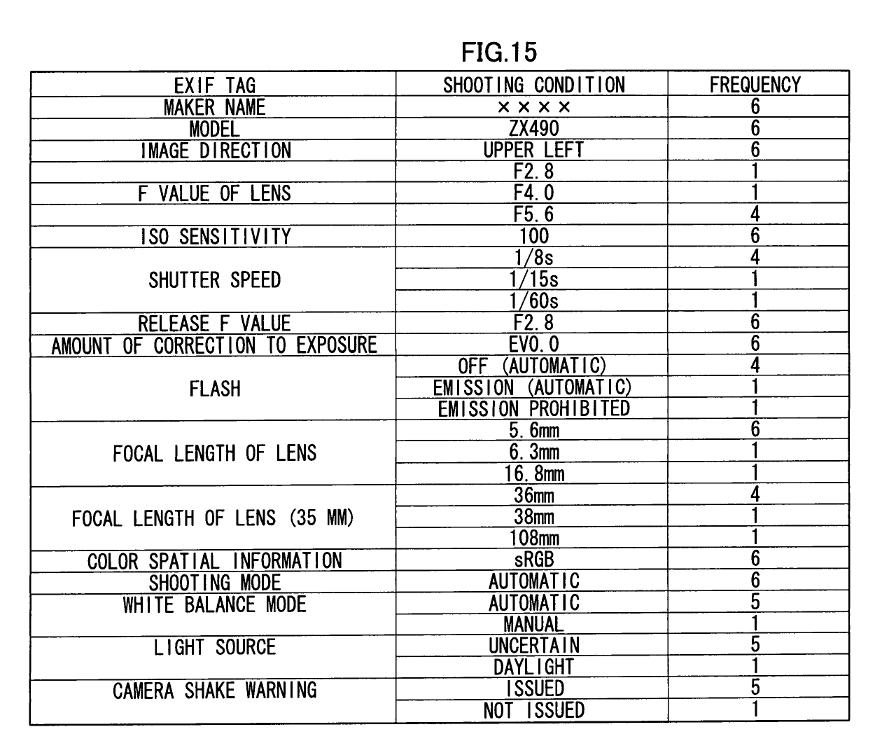

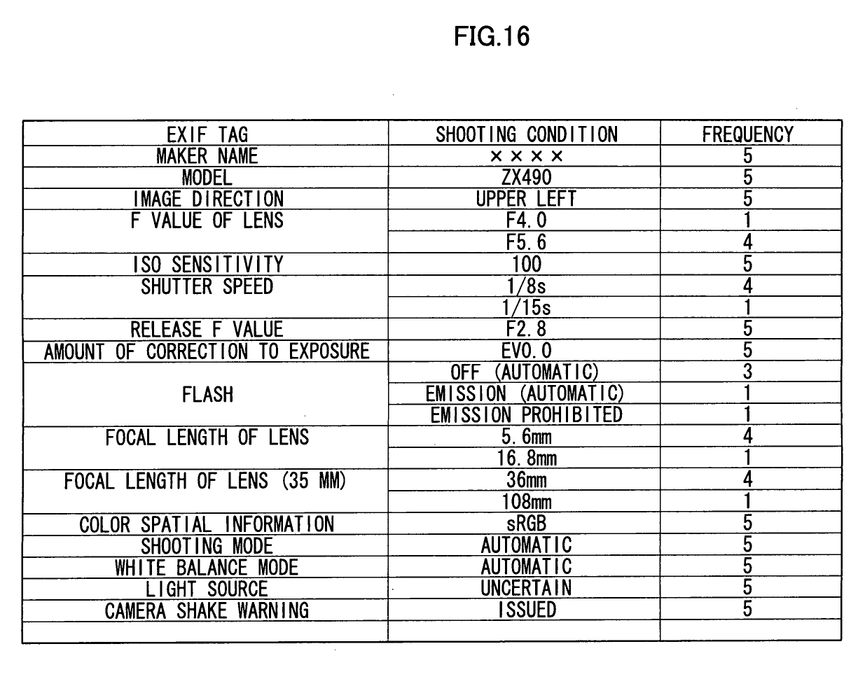

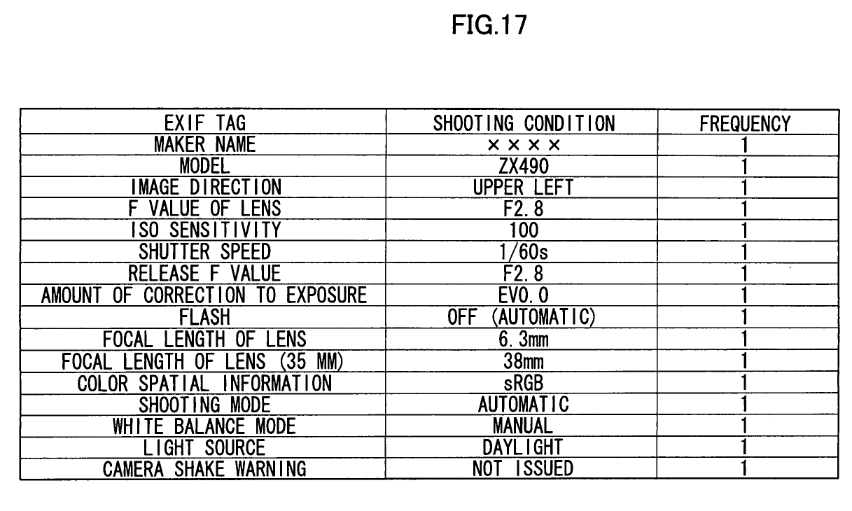

Assume that the user made image quality correction six times on the image to be printed, and the breakdown of the image quality correction is five times for camera shake correction, one time for color correction, and zero for brightness/contrast correction. Then, assume that the statistics of the shooting condition of an image to which the image quality correction is made is shown in FIG. 15, and the statistics of the shooting condition of the image to which camera shake correction is made in the image quality correction is shown in FIG. 16 and the statistics of the shooting condition of the image to which color correction is made in the image quality correction is shown in FIG. 17.

In this case, the most frequently used image quality correction item is camera shake correction. Therefore, a predetermined shooting condition is a camera shake warning. As shown in FIG. 16, since the items of camera shake warnings are “camera shake warning issued” for five times and “no camera shake warning issued” for zero, the most frequently used shooting condition is a “camera shake warning issued”. Therefore, in the case of the example, the image having the shooting condition of “camera shake warning issued” is extracted as an image to be corrected from the image for which print orders are placed.

If an image to be corrected is not extracted, then an image to be corrected is extracted by assuming that a predetermined shooting condition is a “flash” (second highest priority). That is, the most frequently used shooting condition in the flash items is extracted, and an image having the same shooting condition is extracted from among the images for which print orders are placed.

If an image to be corrected cannot be extracted by assuming that a predetermined shooting condition is a “flash”, the predetermined shooting condition is assumed to be a “shutter speed” (third highest priority), and an image to be corrected is extracted. That is, the most frequently used shooting condition in the shutter speed items is extracted, and an image having the same shooting condition is extracted from among the images for which print orders are placed.

Thus, the print acceptance terminal 10 extracts an image having a shooting condition similar to the shooting condition of an image to which image quality correction of the most frequently used image quality correction item is made from the images for which print orders are placed (step S31). Then, the presence/absence of an image to be corrected is determined (step S32).

If an image to be corrected cannot be extracted, the presence/absence of a second frequently used image quality correction item is determined (step S43). If there is a second frequently used image quality correction item, the item is set as the most frequently used image quality correction item (step S44), and an image to be corrected is extracted (step S31).

In the case of the example shown in FIG. 16, since the second frequently used image quality correction item is color correction, the color correction is set as the most frequently used image quality correction item, and an image to be corrected is extracted.

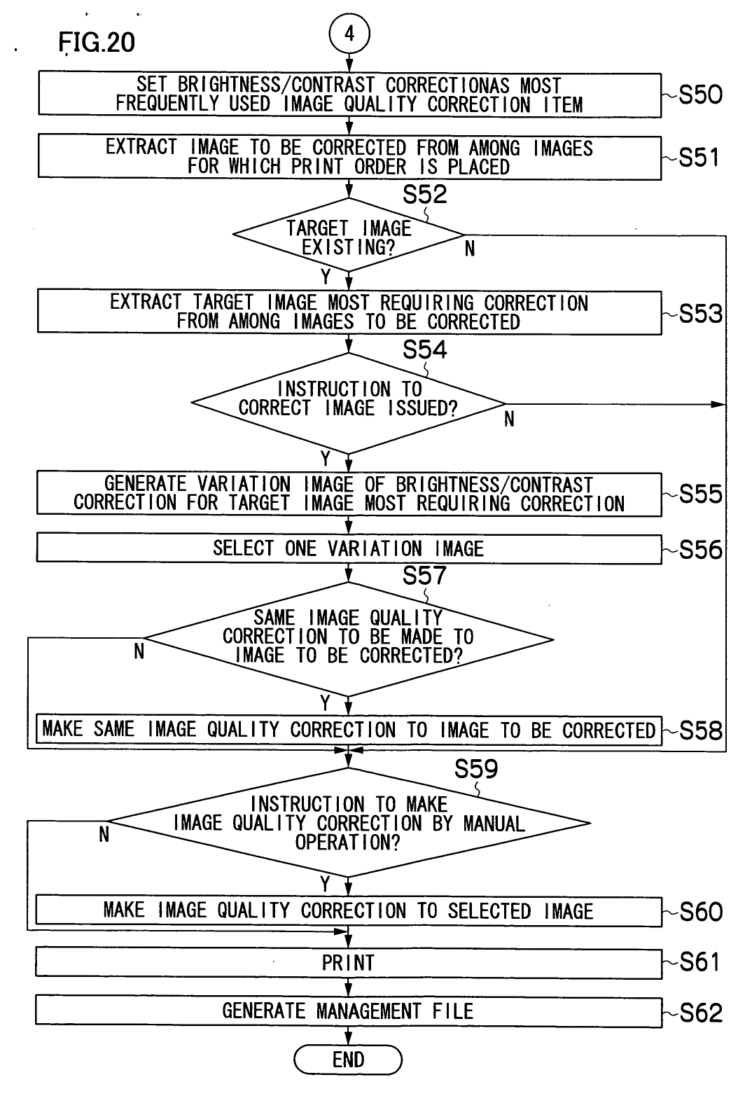

If an image to be corrected cannot be extracted, and there is no second frequently used image quality correction item, then control is passed to step S50 in the flowchart shown in FIG. 20. The process in this case is explained later.

If an image to be corrected is extracted as described above, the target image most requiring correction is extracted from among the extracted images to be corrected (step S33). A target image most requiring correction refers to an image most requiring image quality correction, and an image having a shooting condition the most similar to the shooting condition of the image to which the image quality correction of the most frequently used image quality correction item is made is detected and extracted from among the images to be corrected. In detail, the image is extracted as follows.

First, an image to which the image quality correction of the most frequently used image quality correction item is made is extracted from among the images ever printed based on the print history.

Then, the information about a predetermined shooting condition is obtained from the information about the shooting condition of the extracted image. Assuming that the predetermined shooting condition is set for each image quality correction, for example, the camera shake correction is set in the order of (1) camera shake warning, (2) flash, and (3) shutter speed.

Next, the most frequently used shooting condition of the shooting condition of the highest priority is detected from the information about the obtained and predetermined shooting condition. For example, when the most frequently used image quality correction item is camera shake correction, the priority of a predetermined shooting condition is set in the order of a camera shake warning, a flash, and a shutter speed. Therefore, the most frequently used shooting condition is detected for the camera shake warning. Then, an image having the detected most frequently used shooting condition is extracted from among the images to be corrected.

If one image cannot be selected at this stage, then the most frequently used shooting condition is detected for the shooting condition of the second highest priority. For example, if the most frequently used image quality correction item is camera shake correction, the shooting condition of the second highest priority is “flash”. Therefore, the most frequently used shooting condition is detected relating to the “flash”. An image having the detected most frequently used shooting condition is extracted from among the images to be corrected that have been selected in the first extracting operation.

If an image cannot be selected at this stage, then the most frequently used shooting condition is detected for the shooting condition of the third highest priority. For example, when the most frequently used image quality correction item is camera shake correction, the shooting condition of the third highest priority is “shutter speed”. Therefore, the most frequently used shooting condition is detected relating to the shutter speed. Then, an image having the detected most frequently used shooting condition is extracted from among the images to be corrected that have been selected in the second extracting operation.

As described above, by stepwise increasing the number of shooting conditions to be compared, the matching level with the shooting condition of the image to which the image quality correction of the most frequently used image quality correction item is made is enhanced and one image is finally selected. Then, the one selected image is set as the target image most requiring correction.

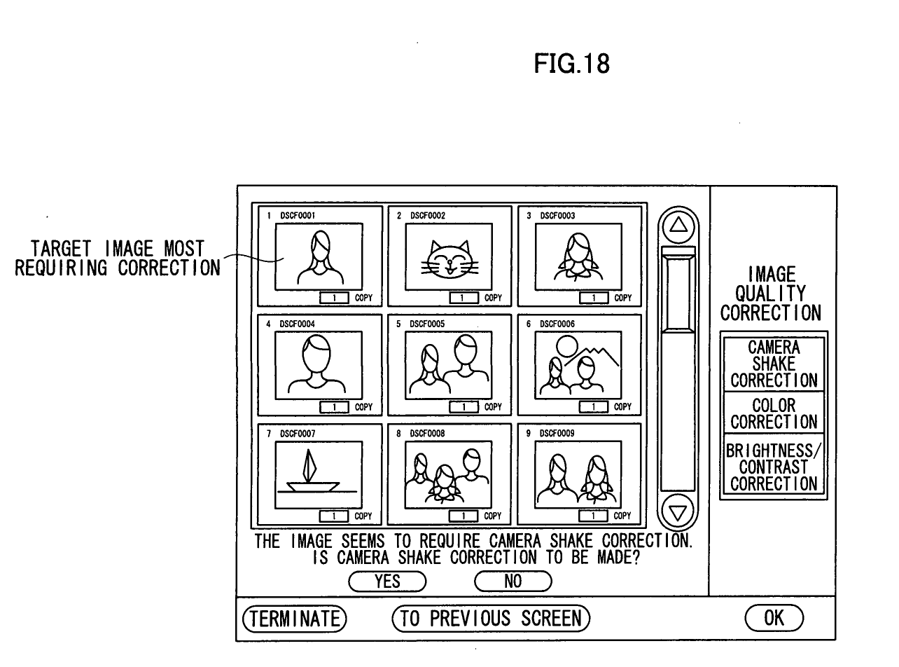

When a target image most requiring correction is extracted, the print acceptance terminal 10 has the display on the display 14 switched to the screen of the image quality correction to the target image most requiring correction. FIG. 18 shows an example of the screen display on the display 14. As shown in FIG. 18, the screen of the image quality correction for the target image most requiring correction is basically the same as the basic screen of the image quality correction shown in FIG. 9, and an image to be printed is listed in the thumbnail display area. However, for the image extracted as the target image most requiring correction, the color of the display frame is displayed as distinguished from the color of the display frame of another image. For the image, a message prompting the image quality correction of the most frequently used image quality correction item (for example, “The image seems to require camera shake correction. Is camera shake correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the target image most requiring correction based on the input from the user (step S34). If it is determined that there is a correct instruction, variation images for image quality correction of the most frequently used image quality correction item are generated for the target image most requiring correction (step S35), and the generated variation images are displayed on the display 14. For example, if the most frequently used image quality correction item is camera shake correction, variation images for camera shake correction are generated for the target image most requiring correction, and the generated variation images are displayed on the display 14 (refer to FIG. 10).

A user touches and selects the thumbnail image of the most desired image in the displayed variation images (including the original image) (step S36). The print acceptance terminal 10 makes image quality correction of the most frequently used image quality correction item to the original image by an amount of correction made to the selected thumbnail image, thereby terminating the process of image quality correction to the target image most requiring correction.

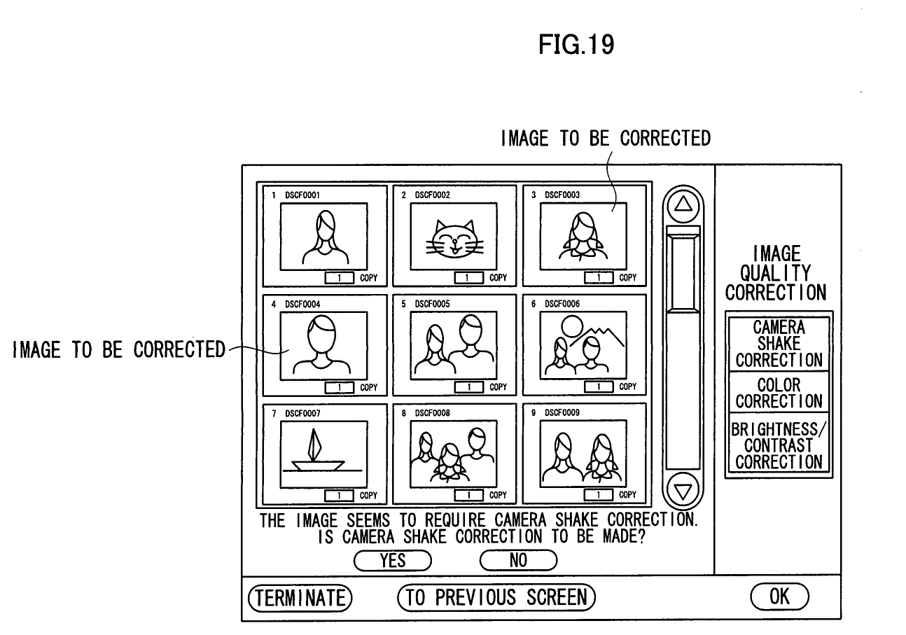

When the process of the image quality correction to the target image most requiring correction is completed, the display 14 of the print acceptance terminal 10 is switched to the screen of the image quality correction to the image to be corrected. FIG. 19 shows an example of the screen display on the display 14 at this time. As shown in FIG. 19, an image to be printed is listed in the thumbnail display area, and the color of the display frame of the image extracted as an image to be corrected (except the target image most requiring correction) is displayed as distinguished from the display frames of other images. For the image, a message prompting the image quality correction of the most frequently used image quality correction item (for example, “The image seems to require camera shake correction. Is camera shake correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the image to be corrected based on the input from the user (step S37). If it is determined that there is a correct instruction, image quality correction of the same item as the target image most requiring correction (image quality correction of the most frequently used image quality correction item) is made to an image to be corrected by the same amount of correction (step S38).

When the process of the image quality correction to the image to be corrected is completed, the display 14 of the print acceptance terminal 10 is switched to the basic screen of the image quality correction shown in FIG. 9. When it is determined in step S37 that there is no instruction to make image quality correction to an image to be corrected, the display on the display 14 is similarly switched to the basic screen of image quality correction. At this time, when image quality correction is being made to an image to be corrected, a corrected image is displayed in the thumbnail display area.

Then, the user determines the presence/absence of image quality correction in a manual operation. When manual correction is made, a button of a desired item of image quality correction is touched, and the process of image quality correction is performed. The print acceptance terminal 10 determines the presence/absence of the instruction to make image quality correction in a manual operation from a user (step S39). If it is determined that there is an instruction, the image quality correction depending on the user operation is made (step S40). The process of the image quality correction is the same as the process (in steps S23 and S24) of the image quality correction made when there is no management file.

When the user completes the process of necessary image quality correction, the user touches the OK button displayed in the secondary operation area, thereby terminating the correcting process. When the process of image quality correction is not performed, the user touched the OK button displayed in the secondary operation area, thereby terminating the correcting process.

When the print acceptance terminal 10 detects the touch on the OK button, it generates print data of an image for which a print order is placed, and the printing process is performed (step S41). That is, the print data generation unit 40 generates print data based on the image data (corrected image data if the image quality of the image is corrected) of the image for which a print order is placed, and the generated print data is added to the print unit 52 and printed on photographic paper.

The generated photographic print is ejected to the print ejector 24, and the user receives the photographic print ejected to the print ejector 24.

On the other hand, after terminating the printing process, the print acceptance terminal 10 transmits the user order data to the management server 100 over a network. The management server 100 generates a management file of a print history based on the order data transmitted from the print acceptance terminal 10 (step S42).

Thus, when there is a print history of a user who placed a print order, the tendency of the image quality correction of the user is estimated based on the print history, thereby automatically setting the image quality correction. Thus, the process of making image quality correction by a user can be omitted, and an order for a print of a desired image can be easily placed.

When the tendency of the image quality correction of a user cannot be estimated based on the print history, or there is no image matching the tendency of the image quality correction ever made by the user, that is, it is determined in step S43 in the flowchart shown in FIG. 13 that there is no second frequently used image quality correction item, the process is performed as follows.

If it is determined in step S43 that there is not the second frequently used image quality correction item, control is passed to step S50 in the flowchart shown in FIG. 20, and the brightness/contrast correction is set to the most frequently used image quality correction item (step S50). Then, the image to be corrected is extracted from among the images to be printed (step S51).

The image to be corrected, that is, each image to be printed, is evenly divided into 100 segments (10×10), each average EV value is calculated, and the maximum value EV_{MAX} and the minimum value EV_{MIN} are obtained. The obtained maximum value EV_{MAX} and the minimum value EV_{MIN} and the difference (ΔEV=EV_{MAX}−EV_{MIN}) are calculated as the brightness difference in the screen. An image having a brightness difference within the screen equal to or larger than a predetermined value set in advance is extracted as an image to be corrected.

From the result of the extracting process, the presence/absence of an image to be corrected is determined (step S52). If there is no image to be corrected, a process of automatically correcting an image is not performed, control is passed to step S59, and to the process of image quality correction by a manual operation. In this case, the display on the display 14 of the print acceptance terminal 10 is a basic screen of the image quality correction shown in FIG. 9.

On the other hand, when an image to be corrected is extracted, a target image most requiring correction is extracted from among the extracted images to be corrected (step S53). The process is performed by extracting an image having the largest brightness difference ΔEV within the screen from among the images to be corrected.

Thus, when a target image most requiring correction is extracted, the print acceptance terminal 10 has the display on the display 14 switched to the screen of the image quality correction to the target image most requiring correction (refer to FIG. 18). As described above, on the screen of the image quality correction for the target image most requiring correction, an image to be printed is listed in the thumbnail display area. For the image extracted as the target image most requiring correction, the color of the display frame is displayed as distinguished from the color of the display frame of another image. For the image, a message prompting the image quality correction of the most frequently used image quality correction item (for example, “The image seems to require brightness/contrast correction. Is brightness/contrast correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the target image most requiring correction based on the input from the user (step S54). If it is determined that there is a correct instruction, variation images for image quality correction of the most frequently used image quality correction item, that is, brightness/contrast correction, are generated for the target image most requiring correction (step S55), and the generated variation images are displayed on the display 14 (refer to FIG. 12).

A user touches and selects the thumbnail image of the most desired image in the displayed variation images (including the original image) (step S56). The print acceptance terminal 10 makes image quality correction of the most frequently used image quality correction item to the original image by an amount of correction made to the selected thumbnail image, thereby terminating the process of image quality correction to the target image most requiring correction.

When the process of the image quality correction to the target image most requiring correction is completed, the display 14 of the print acceptance terminal 10 is switched to the screen of the image quality correction to the image to be corrected (FIG. 19). As shown in FIG. 19, an image to be printed is listed in the thumbnail display area, and the color of the display frame of the image extracted as an image to be corrected (except the target image most requiring correction) is displayed as distinguished from the display frames of other images. For the image, a message prompting the brightness/contrast correction (for example, “The image seems to require brightness/contrast correction. Is brightness/contrast correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the image to be corrected based on the input from the user (step S57). If it is determined that there is a correct instruction, brightness/contrast correction is made to the image to be corrected by the target image most requiring correction and the amount of correction (step S58).

When the process of the image quality correction to the image to be corrected is completed, the display 14 of the print acceptance terminal 10 is switched to the basic screen of the image quality correction shown in FIG. 9. When it is determined in step S37 that there is no instruction to make image quality correction to an image to be corrected, the display on the display 14 is similarly switched to the basic screen of image quality correction. At this time, when image quality correction is being made to an image to be corrected, a corrected image is displayed in the thumbnail display area.

Then, the user determines the presence/absence of image quality correction in a manual operation. When manual correction is made, a button of a desired item of image quality correction is touched, and the process of image quality correction is performed. The print acceptance terminal 10 determines the presence/absence of the instruction to make image quality correction in a manual operation from a user (step S59). If it is determined that there is an instruction, the image quality correction depending on the user operation is made (step S60).

When the user completes the process of necessary image quality correction, the user touches the OK button displayed in the secondary operation area, thereby terminating the correcting process. When the process of image quality correction is not performed, the user touched the OK button displayed in the secondary operation area, thereby terminating the correcting process.

When the print acceptance terminal 10 detects the touch on the OK button, it generates print data of an image for which a print order is placed, and the printing process is performed (step S61). That is, the print data generation unit 40 generates print data based on the image data (corrected image data if the image quality of the image is corrected) of the image for which a print order is placed, and the generated print data is added to the print unit 52 and printed on photographic paper.

The generated photographic print is ejected to the print ejector 24, and the user receives the photographic print ejected to the print ejector 24.

On the other hand, after terminating the printing process, the print acceptance terminal 10 transmits the user order data to the management server 100 over a network. The management server 100 generates a management file of a print history based on the order data transmitted from the print acceptance terminal 10 (step S62).

When the tendency of the image quality correction of a user cannot be estimated based on the print history, or there is no image matching the tendency of the image quality correction ever made by the user, the brightness/contrast correction is set to the most frequently used image quality correction item, and necessary image quality correction is automatically made. Thus, the process of making image quality correction by a user can be omitted, and an order for a print of a desired image can be easily placed.

Explained below is the process performed when there is an image to be repeat-printed in the images for which print order are placed. That is, the process performed when it is determined in step S18 in the flowchart shown in FIG. 5 that there is an image to be repeat-printed is explained below.

If it is determined in step S18 in the flowchart shown in FIG. 5 that there is an image to be repeat-printed, control is passed to step S70 in the flowchart shown in FIG. 21.

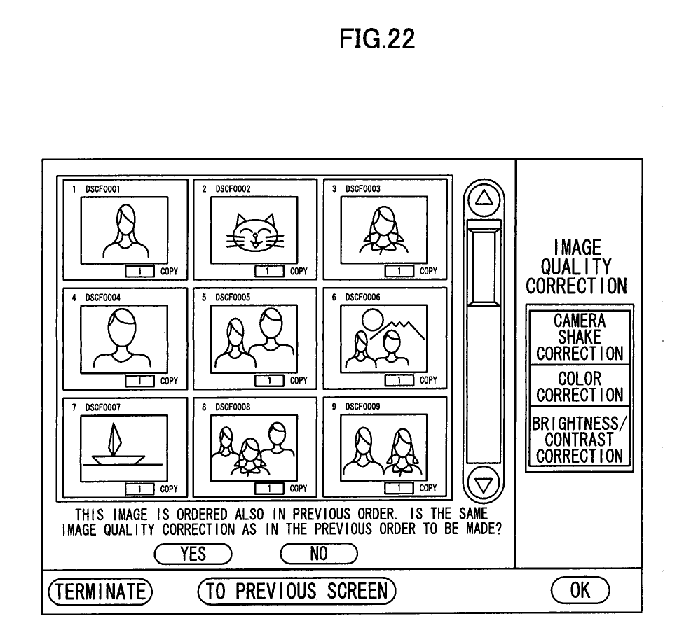

First, the display on the display 14 is switched to the screen of the image quality correction to a repeat print image. FIG. 22 shows an example a screen display of the display 14. As shown in FIG. 22, the screen of the image quality correction to a repeat print image is basically the same as the basic screen of the image quality correction shown in FIG. 9, and an image to be printed is listed in the thumbnail display area. However, the color of the display frame of a repeat print image is displayed as distinguished from the color of the display frame of a newly ordered image. Then, a message as to whether or not the same image quality correction as in the previous order is to be made to the repeat print image (“This image is the same as the previously ordered image. Is the same image quality correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of the instruction to make image quality correction to the repeat print image based on the input from the user (step S70). If it is determined that there is no correct instruction, control is passed to step S72. If it is determined that there is a correct instruction, the same image quality correction as in the previous order is made based on the print history (step S71).

Then, the print acceptance terminal 10 determines the presence/absence of a newly ordered image (step S72). If it is determined that there is no newly ordered image, the print data generation unit 40 generates print data based on the image data of the data for which a print order is placed, adds the generated print data to the print unit 52, and prints it on photographic paper (step S73).

The generated photographic print is ejected to the print ejector 24, and the user receives the photographic print ejected to the print ejector 24.

On the other hand, after terminating the printing process, the print acceptance terminal 10 transmits the user order data to the management server 100 over a network. The management server 100 generates a management file of a print history based on the order data transmitted from the print acceptance terminal 10 (step S74).

Thus, for an image to be repeat-printed, the same image quality correction as in the previous printing process is automatically set, thereby allowing the user to omit the trouble of making image quality correction again, and easily placing a print order for a desired image.

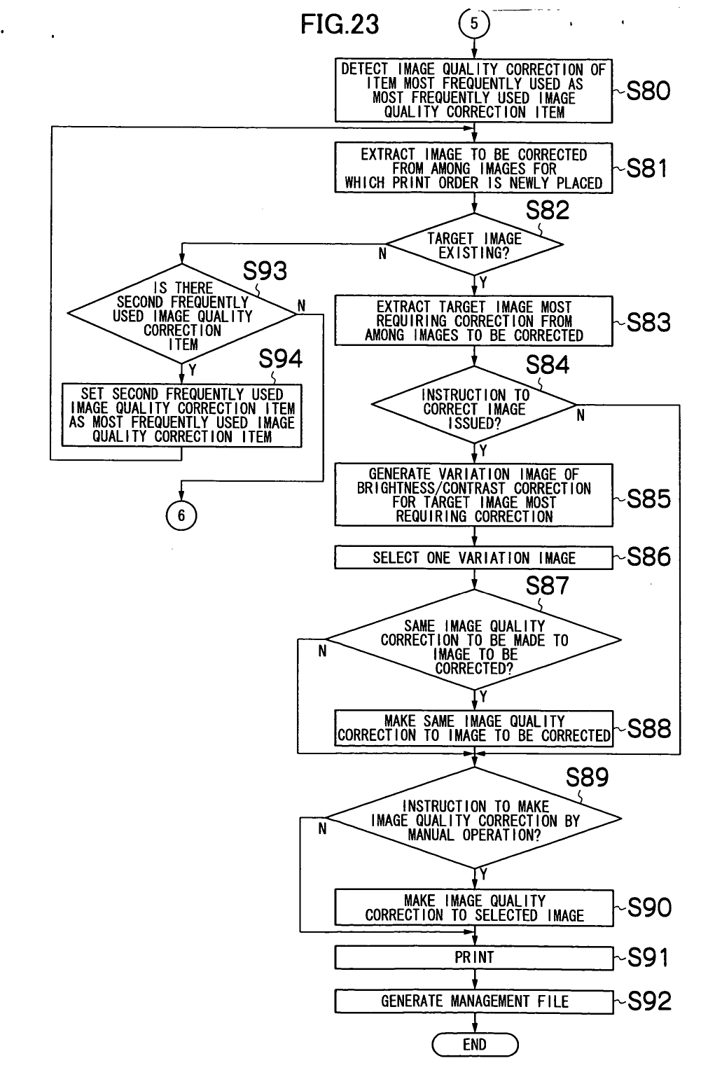

If it is determined in step S72 that there is a newly ordered image, a print acceptance terminal 82 passes control to the process in step S80 in the flowchart shown in FIG. 23.

First, the print acceptance terminal 10 detects the most frequently used image quality correction item based on the print history of a user obtained from the management server 100 (step S80), and extracts an image to be corrected from among the images for which print orders are newly placed (step S81). This process is basically the same as the process in step S31 in the flowchart shown in FIG. 13. That is, the image of the shooting condition similar to the shooting condition of the image to which image quality correction of the most frequently used image quality correction item is made is extracted from among the images for which print orders are newly placed.

Thus, the process of extracting an image to be corrected from among the images for which print orders are newly placed is performed, and it is determined whether or not there is an image to be corrected (step S82). If no image to be corrected can be extracted, it is determined whether or not there is a second frequently used image quality correction item (step S93). When there is a second frequently used image quality correction item, the item is set as the most frequently used image quality correction item (step S94), and an image to be corrected is extracted (step S81).

When images to be corrected are extracted, the target image most requiring correction is extracted from among the extracted images to be corrected (step S83). That is, an image of the shooting condition most similar to the shooting condition of the image to which the image quality correction of the most frequently used image quality correction item is made is detected and extracted from among the images to be corrected. The process is basically the same as the process in step S33 in the flowchart shown in FIG. 13.

When the target image most requiring correction is extracted as described above, the display on the display 14 of the print acceptance terminal 10 is switched to the screen of the image quality correction for the target image most requiring correction (refer to FIG. 18). As described above, the screen of the image quality correction for the target image most requiring correction is basically the same as the basic screen of the image quality correction shown in FIG. 9, and image to be printed are listed in the thumbnail display area. However, the color of the display frame of the image extracted as the target image most requiring correction is displayed as distinguished from the colors of the display frames of the other images. For the image, a message prompting the image quality correction of the most frequently used image quality correction item (for example, “The image seems to require camera shake correction. Is camera shake correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the target image most requiring correction based on the input from the user (step S84). If it is determined that there is a correct instruction, variation images for image quality correction of the most frequently used image quality correction item are generated for the target image most requiring correction (step S85), and the generated variation images are displayed on the display 14.

A user touches and selects the thumbnail image of the most desired image in the displayed variation images (including the original image) (step S86). The print acceptance terminal 10 makes image quality correction of the most frequently used image quality correction item to the original image by an amount of correction made to the selected thumbnail image, thereby terminating the process of image quality correction to the target image most requiring correction.

When the process of the image quality correction to the target image most requiring correction is completed, the display 14 of the print acceptance terminal 10 is switched to the screen of the image quality correction to the image to be corrected (FIG. 19). In the screen of the image quality correction for an image to be corrected, an image to be printed is listed in the thumbnail display area, and the color of the display frame of the image extracted as an image to be corrected (except the target image most requiring correction) is displayed as distinguished from the display frames of other images. For the image, a message prompting the image quality correction of the most frequently used image quality correction item (for example, “The image seems to require camera shake correction. Is camera shake correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the image to be corrected based on the input from the user (step S87). If it is determined that there is a correct instruction, the image quality correction of same item (image quality correction of the most frequently used image quality correction item) as the target image most requiring correction is made to the image to be corrected by the same amount of correction (step S88).

When the process of the image quality correction to the image to be corrected is completed, the display 14 of the print acceptance terminal 10 is switched to the basic screen of the image quality correction shown in FIG. 9. When it is determined in step S87 that there is no instruction to make image quality correction to an image to be corrected, the display on the display 14 is similarly switched to the basic screen of image quality correction. At this time, when image quality correction is being made to an image to be corrected, a corrected image is displayed in the thumbnail display area.

Then, the user determines the presence/absence of image quality correction in a manual operation. When manual correction is made, a button of a desired item of image quality correction is touched, and the process of image quality correction is performed. The print acceptance terminal 10 determines the presence/absence of the instruction to make image quality correction in a manual operation from a user (step S89). If it is determined that there is an instruction, the image quality correction depending on the user operation is made (step S90). The process of the image quality correction is the same as the process (steps S23 and S24) of the image quality correction made when there is no above-mentioned management file.

When the user completes the process of necessary image quality correction, the user touches the OK button displayed in the secondary operation area, thereby terminating the correcting process. When the process of image quality correction is not performed, the user touched the OK button displayed in the secondary operation area, thereby terminating the correcting process.

When the print acceptance terminal 10 detects the touch on the OK button, it generates print data of an image for which a print order is placed, and the printing process is performed (step S91). That is, the print data generation unit 40 generates print data based on the image data (corrected image data if the image quality of the image is corrected) of the image for which a print order is placed, and the generated print data is added to the print unit 52 and printed on photographic paper.

The generated photographic print is ejected to the print ejector 24, and the user receives the photographic print ejected to the print ejector 24.

On the other hand, after terminating the printing process, the print acceptance terminal 10 transmits the user order data to the management server 100 over a network. The management server 100 generates a management file of a print history based on the order data transmitted from the print acceptance terminal 10 (step S92).

Thus, when there is a print history of a user who places a print order, the tendency of the image quality correction of the user is estimated based on the print history, and the image quality correction of the image for which a new order is automatically placed is set. Thus, a print order can be easily placed for a desired image without the trouble of a user making image quality correction.

When the tendency of the image quality correction of a user cannot be estimated based on the print history, or there is no image matching the tendency of the image quality correction ever made by the user, that is, it is determined in step S93 in the flowchart shown in FIG. 23 that there is no second frequently used image quality correction item, the process is performed as follows.

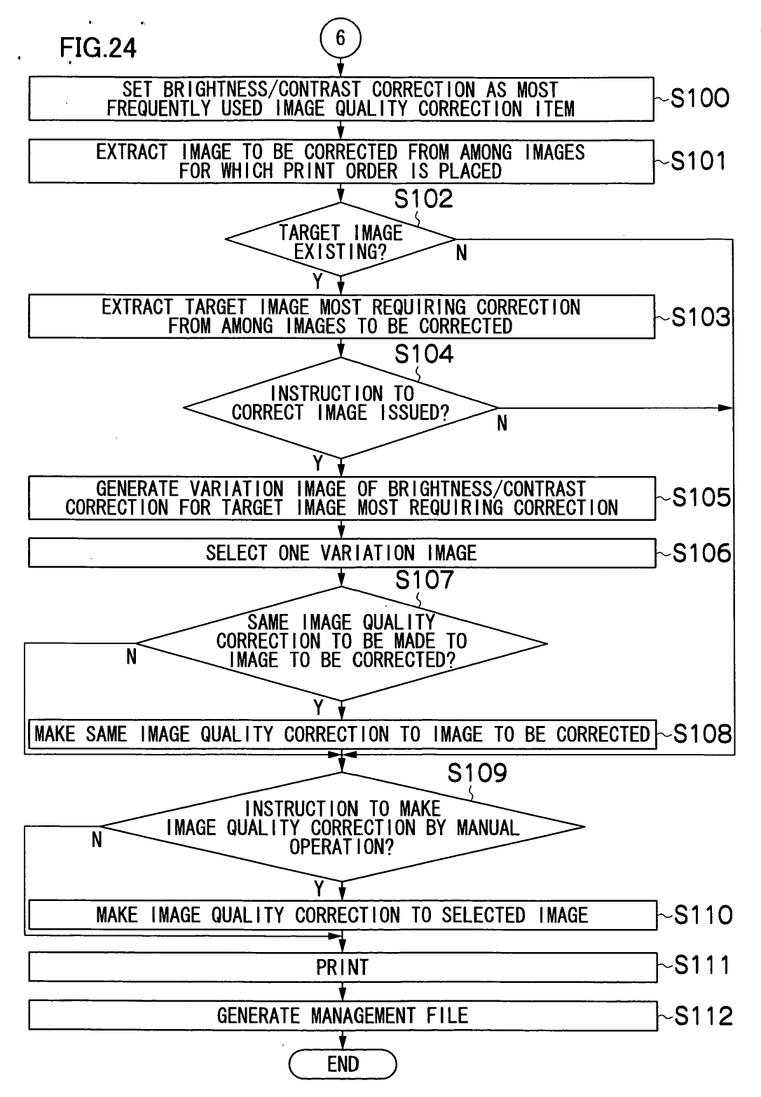

If it is determined in step S43 that there is not the second frequently used image quality correction item, control is passed to step S100 in the flowchart shown in FIG. 24, and the brightness/contrast correction is set to the most frequently used image quality correction item (step S100). Then, the image to be corrected is extracted from among the images for which new orders are placed (step S101). This process is basically the same as the process in S51 in the flowchart shown in FIG. 20.

From the result of the extracting process, the presence/absence of an image to be corrected is determined (step S102). If there is no image to be corrected, a process of automatically correcting an image is not performed, control is passed to step S109, and to the process of image quality correction by a manual operation. In this case, the display on the display 14 of the print acceptance terminal 10 is a basic screen of the image quality correction shown in FIG. 9.

On the other hand, when an image to be corrected is extracted, a target image most requiring correction is extracted from among the extracted images to be corrected (step S103). This process is basically the same as the process in step S53 in the flowchart shown in FIG. 20 above. The process is performed by extracting an image having the largest brightness difference ΔEV within the screen from among the images to be corrected.

Thus, when a target image most requiring correction is extracted, the print acceptance terminal 10 has the display on the display 14 switched to the screen of the image quality correction to the target image most requiring correction (refer to FIG. 18). As described above, on the screen of the image quality correction for the target image most requiring correction, an image to be printed is listed in the thumbnail display area. For the image extracted as the target image most requiring correction, the color of the display frame is displayed as distinguished from the color of the display frame of other images. For the image, a message prompting the image quality correction of the most frequently used image quality correction item (for example, “The image seems to require brightness/contrast correction. Is brightness/contrast correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the target image most requiring correction based on the input from the user (step S104). If it is determined that there is a correct instruction, variation images for image quality correction of the most frequently used image quality correction item, that is, brightness/contrast correction, are generated for the target image most requiring correction (step S105), and the generated variation images are displayed on the display 14 (refer to FIG. 12).

A user touches and selects the thumbnail image of the most desired image in the displayed variation images (including the original image) (step S106). The print acceptance terminal 10 makes image quality correction of the most frequently used image quality correction item to the original image by an amount of correction made to the selected thumbnail image, thereby terminating the process of image quality correction to the target image most requiring correction.

When the process of the image quality correction to the target image most requiring correction is completed, the display 14 of the print acceptance terminal 10 is switched to the screen of the image quality correction to the image to be corrected (FIG. 19). As shown in FIG. 19, in the screen of the image quality correction for an image to be corrected, an image to be printed is listed in the thumbnail display area, and the color of the display frame of the image extracted as an image to be corrected (except the target image most requiring correction) is displayed as distinguished from the display frames of other images. For the image, a message prompting the brightness/contrast correction (for example, “The image seems to require brightness/contrast correction. Is brightness/contrast correction to be made?”) is displayed in the thumbnail display area.

If the user makes the image quality correction upon receipt of the message, the user touches the “YES” button displayed together with the message. If the image quality correction is not made, the user touches the “NO” button displayed together with the message.

The print acceptance terminal 10 determines the presence/absence of a correct instruction for the image to be corrected based on the input from the user (step S107). If it is determined that there is a correct instruction, brightness/contrast correction is made to the image to be corrected by the target image most requiring correction and the amount of correction (step S108).

When the process of the image quality correction to the image to be corrected is completed, the display 14 of the print acceptance terminal 10 is switched to the basic screen of the image quality correction shown in FIG. 9. When it is determined in step S37 that there is no instruction to make image quality correction to an image to be corrected, the display on the display 14 is similarly switched to the basic screen of image quality correction.

At this time, when image quality correction is made to the image to be corrected, a corrected image is displayed in the thumbnail display area. Then, the user determines the presence/absence of image quality correction in a manual operation. When manual correction is made, a button of a desired item of image quality correction is touched, and the process of image quality correction is performed. The print acceptance terminal 10 determines the presence/absence of the instruction to make image quality correction in a manual operation from a user (step S109). If it is determined that there is an instruction, the image quality correction depending on the user operation is made (step S110).

When the user completes the process of necessary image quality correction, the user touches the OK button displayed in the secondary operation area, thereby terminating the correcting process. When the process of image quality correction is not performed, the user touched the OK button displayed in the secondary operation area, thereby terminating the correcting process.

When the print acceptance terminal 10 detects the touch on the OK button, it generates print data of an image for which a print order is placed, and the printing process is performed (step S111). That is, the print data generation unit 40 generates print data based on the image data (corrected image data if the image quality of the image is corrected) of the image for which a print order is placed, and the generated print data is added to the print unit 52 and printed on photographic paper.

The generated photographic print is ejected to the print ejector 24, and the user receives the photographic print ejected to the print ejector 24.

On the other hand, after terminating the printing process, the print acceptance terminal 10 transmits the user order data to the management server 100 over a network. The management server 100 generates a management file of a print history based on the order data transmitted from the print acceptance terminal 10 (step S112).

When a new image is processed and the tendency of the image quality correction of a user cannot be estimated based on the print history, or there is no image matching the tendency of the image quality correction ever made by the user, the brightness/contrast correction is set to the most frequently used image quality correction item, and necessary image quality correction is automatically made. Thus, the process of making image quality correction by a user can be omitted, and an order for a print of a desired image can be easily placed.

As described above, according to the printing system 1 of the present embodiment, the settings of necessary image quality correction are automatically set by referring to the print history of the correction ever made by the user. Therefore, the user can be free of the troublesome settings of image quality correction, and a print of desired image quality can be easily obtained.

According to the present embodiment, a printer (print unit) is incorporated into a print acceptance terminal, but a print acceptance terminal and a printer can be separately configured. That is, a print acceptance terminal can be configured to perform only the process of accepting a print order, and a printing operation can be performed by another device.

Although each print acceptance terminal 10 is connected to the management server 100 over a network in the present embodiment, the connection between the print acceptance terminal 10 and the management server 100 is not limited to this configuration.

Additionally, according to the present embodiment, an item of executable image quality correction can be camera shake correction, color correction, and brightness/contrast correction, but these are only example, and other image quality correction can be made. For example, sharpness correction, chroma correction, color correction, etc. can be made.

The method of extracting the most frequently used image quality correction item explained according to the present embodiment is an example, and the most frequently used image quality correction item can be extracted in other methods. Similarly, the methods of extracting an image to be corrected and a target image most requiring correction are examples, and they can be extracted in other methods. That is, any method of estimating the tendency (aptitude) in a client correcting an image based on the print history of the client, and extracting a required image by the correction can be adopted.

Furthermore, a management file of a print history is not centrally managed by a management server, but each print acceptance terminal can individually manage the file. In this case, each print acceptance terminal can be connected to each other such that communications can be established and the management file can be updated by periodically exchanging information.

Additionally, a management file can be managed not by a management server, but can be managed after stored on a user storage medium. In this case, the authenticating process using an ID and a password can be omitted, and a management server can also be omitted. When management files are stored in both management server and storage medium, one of the files can be used on a priority basis, or the files can be integrally used.

The printing system 1 according to the present embodiment can also print a RAW image. Described below is the process of printing a RAW image.

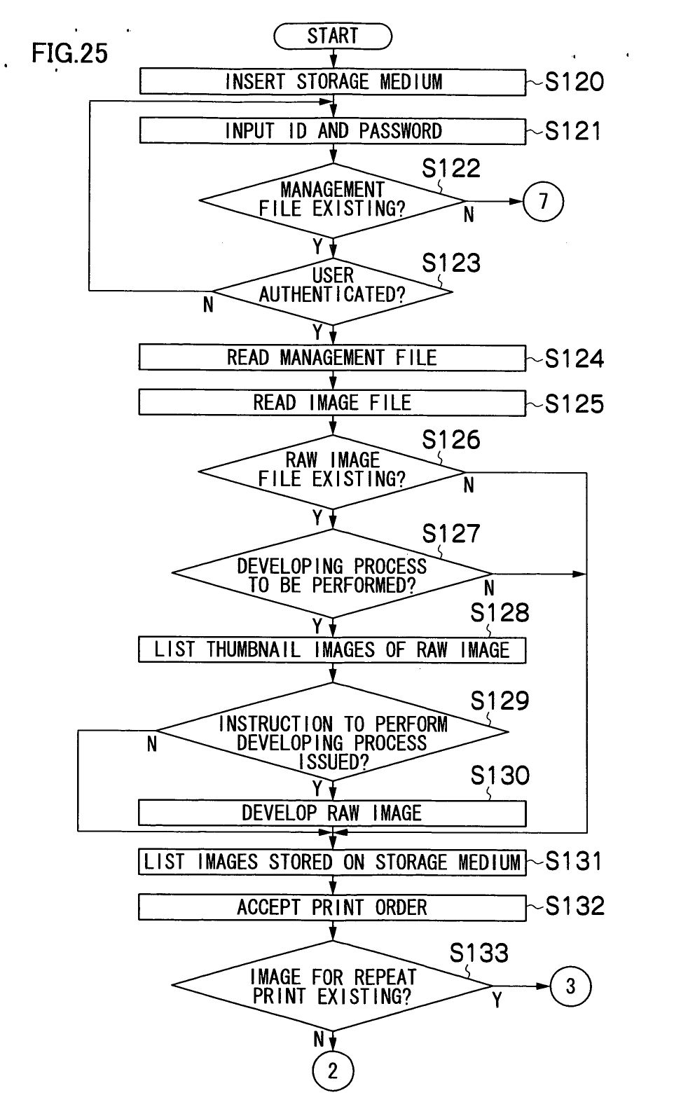

FIG. 25 is a flowchart of the procedure of the process performed when a RAW image is printed.

First, a user inserts a storage medium such as a memory card, etc. on which image data is recorded into the medium slot 16 (step S120), and allows the print acceptance terminal 10 to start the process of placing a print order.

When an order process is started, an input screen of an ID and a password is displayed on the display 14 (refer to FIG. 6). A client inputs an ID and a password according to the display on the display 14 (step S121). An ID and a password can be formed by, for example, numbers, alphabetical characters, or a combination of them, and the numbers or alphabetical characters can be input by a touch of them displayed on the display 14.

When an ID and a password are input, the print acceptance terminal 10 accesses the management server 100, and asks the management server 100 whether or not there is a management file corresponding to the input ID.

The management server 100 retrieves a management file corresponding to the ID input by a client from a predetermined storage area according to the information about the ID and the password transmitted from the print acceptance terminal 10, thereby determining the presence/absence of a management file (step S122).

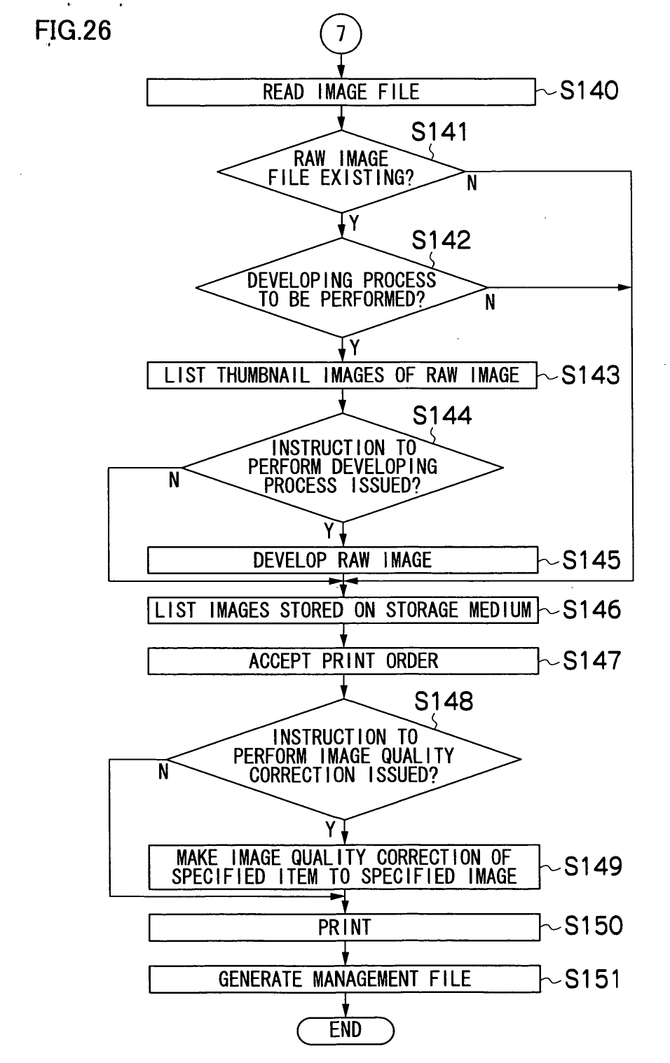

If it is determined that there is no management file, control is passed to step S140 in the flowchart shown in FIG. 26.

First, the print acceptance terminal 10 reads an image file recorded on a storage medium from the storage medium inserted into the medium slot 16 (step S140). Then, a RAW image is detected from the read image files, and it is determined whether or not there is a RAW image file (step S141).

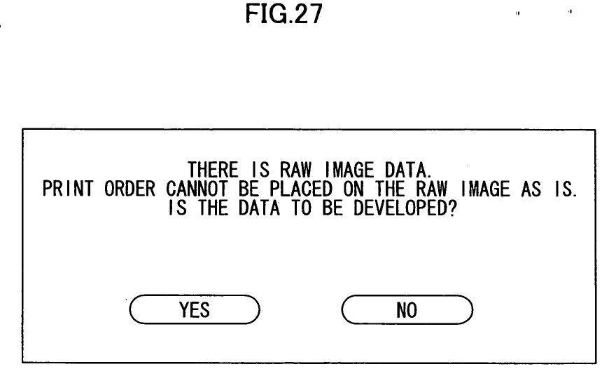

If it is determined that there is a RAW image file, the print acceptance terminal 10 displays a message (for example, “There is RAW data. With the RAW data as is, a print order cannot be placed. Is a developing process to be performed?”) on the display 14 to inquire whether or not a developing process is to be performed as shown in FIG. 27.

When a user performs a developing process in response to the message, the user touches the “YES” button displayed together with the message. When the user does not perform the developing process, the user touches the “NO” button displayed together with the message. The print acceptance terminal 10 determines the presence/absence of an instruction to perform the developing process based on the input from the user (step S142).

If it is determined that there is an instruction to perform the developing process, the print acceptance terminal 10 performs the developing process on the RAW image data, and lists the thumbnail images on the display 14 (step S143). In this case, the thumbnail images of the RAW image are assigned identification symbols (for example, “RAW”) in the display frame to indicate a RAW image.

If a RAW image file is assigned image data of thumbnail images, the developing process is not performed, but thumbnail images of a RAW image are displayed using the image data of the thumbnail images.

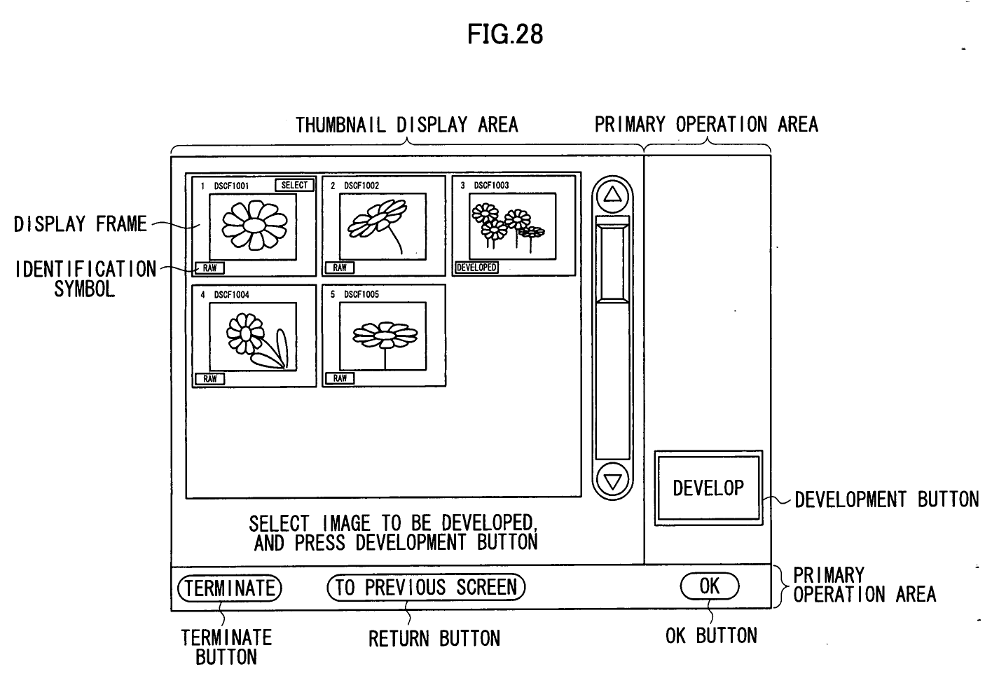

FIG. 28 shows an example of the display of the developing process of a RAW image. As shown in FIG. 28, the screen of the developing process is formed by a thumbnail display area, a primary operation area, and a secondary operation area. In the thumbnail display area, the thumbnail images of a RAW image in the storage medium are listed. In the primary operation area, a development button to instruct a developing process to be performed is displayed. In the secondary operation area, a button (OK button) for directing determination of a process, a button (return button) for directing return to the previous process screen, a button (terminate button) for directing termination, etc. are displayed.

The user directs the developing process for each RAW image according to the screen display of the developing process displayed on the display 14. That is, first, the user touches a thumbnail images of the RAW image to be developed, and selects a RAW image to be developed. When the user touches the thumbnail image, the color of the display frame of the touched thumbnail image changes, and the selected image is distinguished from the other images. In the example shown in FIG. 28, the image (file name: DSCF1001) positioned at the upper left on the screen is selected. The developed file is displayed with an identification symbol (for example, “developed”) in the display frame to indicate that the developing process is performed (displayed instead of the identification symbol of the RAW image).

Thus, after touching and selecting the image for which a print order is placed, the user touches the development button displayed in the primary operation area, and directs the developing process to be performed. The print acceptance terminal 10 determines the presence/absence of the instruction to perform the developing process based on the input instruction from the user (step S144), and performs the developing process on the specified RAW image (step S145). That is, the RAW image data of the selected thumbnail image is added to the developing unit 38, and a necessary developing process is performed.

After performing the developing process on the RAW image requiring the developing process, a user touches the OK button displayed in the secondary operation area, thereby terminating the developing process.

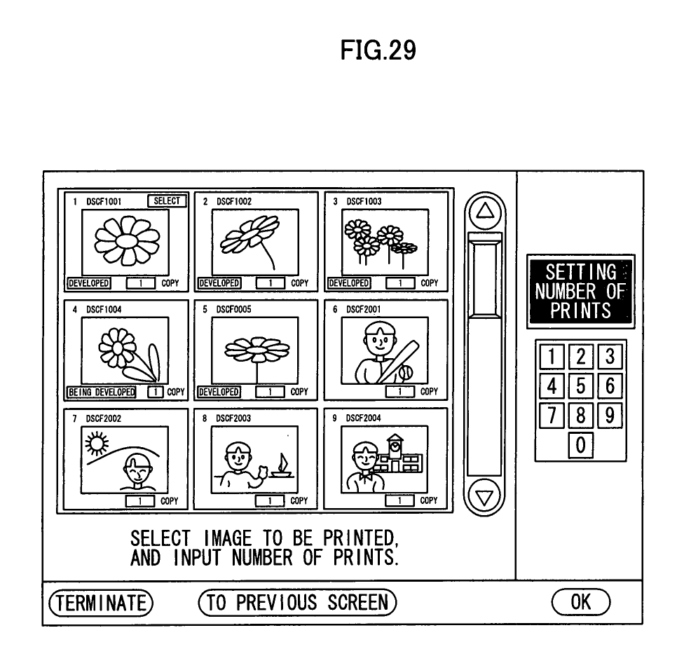

When the developing process is completed, the display on the display 14 of the print acceptance terminal 10 is switched to the display on the acceptance screen of a print order. FIG. 29 shows an example of displaying the acceptance screen of a print order. As shown in FIG. 29, the acceptance screen of a print order is basically the same as the acceptance screen of the print order shown in FIG. 8, and the thumbnail images of the image file on the storage medium are listed in the thumbnail display area (step S146).

However, relating to the RAW image, only a developed image is displayed, and an undeveloped image is not displayed. Also relating to a RAW image, an identification symbol (for example, “developed”) is assigned and displayed in the display frame to indicate a RAW image.

When it is determined that there is no RAW image file in the above-mentioned step S141, and when it is determined that there is no instruction to perform the developing process in step S142, the display on the display 14 is switched to the acceptance screen of the print order.

The user inputs a print order according to the display on the acceptance screen of the print order displayed on the display 14 (step S147). After completing the input of the number of all images for which print orders are placed, the user touches the OK button displayed in the secondary operation area, and determines the orders.

When the settings of a print order are completed, the display on the display 14 is switched from the screen of a print order to the basic screen of image quality correction (refer to FIG. 9), and a user makes image quality correction by a manual operation as necessary.

The print acceptance terminal 10 determines the presence/absence of an instruction to perform image quality correction in the manual operation depending on the input from a user (step S148). If it is determined that there is the instruction, the image quality correction is made to the specified item by the specified amount of correction (step S149).

Afterwards, when the process of image quality correction is completed, the print acceptance terminal 10 generates the print data of the image for which a print order is placed, and a printing process is performed (step S150). The generated photographic print is ejected to the print ejector 24, and the user receives the photographic print ejected to the print ejector 24.

On the other hand, after terminating the printing process, the print acceptance terminal 10 transmits the user order data (necessary data for generation of a management file of a print history such as the file name of an image for which a print order is placed, Exif information, the contents of image quality correction, etc.) to the management server 100 over a network. The management server 100 generates a management file of a print history based on the order data transmitted from the print acceptance terminal 10 (step S151). In the present embodiment, since the user is a new user, an ID and a password are set at this stage.

As described above, if a user is a new user having no management file in the management server 100, and a RAW image is included in the images to be printed, then a necessary developing process is performed and the user manually makes image quality correction as necessary, and prints an image.

When a user has a management file in the management server 100, that is, when it is determined in step S122 in the flowchart shown in FIG. 25 that there is a management file, the process is performed as follows.

If it is determined in step S122 in the flowchart shown in FIG. 25 that there is a management file, an authenticating process is performed based on the input password (step S123). That is, it is determined whether or not the input password matches the password set in the corresponding management file, and the user can be authenticated.

If the passwords do not match each other, control is returned to S121, and an ID and a password are input again.

On the other hand, if the passwords match each other, and the user can be successfully authenticated, the print acceptance terminal 10 reads the corresponding management file from the management server 100 (step S124), and reads an image file recorded on the storage medium from the storage medium inserted into the medium slot 16 (step S125). Then, a RAW image is detected from the read image files, and it is determined whether or not there is a RAW image file (step S126).

If it is determined that there is a RAW image file, the print acceptance terminal 10 displays a message (for example, “There is RAW data. With the RAW data as is, a print order cannot be placed. Is a developing process to be performed?”) on the display 14 to inquire whether or not a developing process is to be performed (refer to FIG. 27).

If the user performs a developing process upon receipt of the message, the user touches the “YES” button displayed together with the message. If a developing process is not performed, the user touches the “NO” button displayed together with the message. The print acceptance terminal 10 determines the presence/absence of a correct instruction for the target image most requiring correction based on the input from the user (step S127).

If it is determined that there is an instruction to perform a developing process, the print acceptance terminal 10 performs a developing process on RAM image data, and lists the thumbnail images on the display 14 as shown in FIG. 28 (step S128). The user issues an instruction to perform a developing process for each RAW image according to the screen display of the developing process displayed on the display 14. The print acceptance terminal 10 determines the presence/absence of the instruction to perform the developing process based on the input instruction from the user (step S129), and performs the developing process on the specified RAW image (step S130). That is, the RAW image data of the selected thumbnail image is added to the developing unit 38, and a necessary developing process is performed.

After performing the developing process on the RAW image requiring the developing process, a user touches the OK button displayed in the secondary operation area, thereby terminating the developing process.

When the developing process is completed, the display on the display 14 of the print acceptance terminal 10 is switched to the display of the acceptance screen of a print order, and thumbnail images of an image file on the storage medium are listed in the thumbnail display area (step S131). In this case, as described above, relating to a RAW image, only a developed image is displayed. Additionally, relating to a RAW image, an identification symbol (for example, “developed”) is assigned and displayed in the display frame to indicate a RAW image.

The user inputs a print order according to the display on the acceptance screen of the print order displayed on the display 14 (step S132). After completing the input of the number of all images for which print orders are placed, the user touches the OK button displayed in the secondary operation area, and determines the orders.

When the settings of a print order is completed, the print acceptance terminal 10 determines the presence/absence of the image of the repeat print (repeat order) in the images for which print orders are placed based on the print history (step S133).

If there is no image for repeat print as a result of the determination, control is passed to step S30 in the flowchart shown in FIG. 13. If there is an image for repeat print, control is passed to step S70 in the flowchart shown in FIG. 21.

As explained above, since the printing system 1 according to the present embodiment has the function of developing a RAW image, the RAW image can be developed as necessary and printed although it is contained in the images to be printed.

What is claimed is:

1. A printing method of an image for which a client places a print order by making an image quality correction to an item indicated by the client, comprising:
managing a print history of a client individually for each client;
detecting an image for which an order for repeat print is placed as an image to be repeat-printed, from among images for which print orders are accepted from the client, based on the print history; and
setting an item of image quality correction and an amount of correction based on the print history such that the same image quality correction as the image quality correction made before to the image to be repeat-printed can be made.

2. The printing method according to claim 1, wherein on an image for which a print order is newly placed,
a most frequently used item of image quality correction in items of image quality correction made before by a client who places a print order is detected as a most frequently used image quality correction item from the print history;
an image requiring image quality correction of the detected most frequently used image quality correction item is extracted as an image to be corrected from among images for which print orders are newly placed based on the print history;
an image most requiring image quality correction is extracted as a target image most requiring correction from among extracted images to be corrected based on the print history;
a plurality of sample images are generated by stepwise changing an amount of correction of the extracted target image most requiring correction and making image quality correction to the most frequently used image quality correction item;
one of the plurality of generated sample images is selected; and
an item of image quality correction to be made to the image to be corrected and an amount of correction are set such that the same image quality correction as the image quality correction made to the selected sample image can be made.

3. The printing method of printing an image for which a client places a print order by making an image quality correction to an item indicated by the client according to claim 1, wherein:
a print history of a client is individually managed for each client;
a most frequently used item of image quality correction in items of image quality correction made before by a client who places a print order is detected as a most frequently used image quality correction item from the print history;
an image requiring image quality correction of the detected most frequently used image quality correction item is extracted as an image to be corrected from among images for which print orders are newly placed based on the print history;
an image most requiring image quality correction is extracted as a target image most requiring correction from among extracted images to be corrected based on the print history;
a plurality of sample images are generated by stepwise changing an amount of correction of the extracted target image most requiring correction and making image quality correction to the most frequently used image quality correction item;
one of the plurality of generated sample images is selected; and
an item of image quality correction to be made to the image to be corrected and an amount of correction are set such that the same image quality correction as the image quality correction made to the selected sample image can be made.

4. The printing method according to claim 2, wherein
the image to be corrected is extracted by detecting an image having the same shooting condition as a prescribed shooting condition of an image to which image quality correction of the most frequently used image quality correction item is made from among images for which print orders are newly placed.

5. The printing method according to claim 3, wherein
the image to be corrected is extracted by detecting an image having the same shooting condition as a prescribed shooting condition of an image to which image quality correction of the most frequently used image quality correction item is made from among images for which print orders are newly placed.

6. The printing method according to claim 2, wherein
the image to be corrected is extracted by detecting an image having a shooting condition most matching a prescribed shooting condition of an image to which image quality correction of the most frequently used image quality correction item is made from among the images to be corrected.

7. The printing method according to claim 3, wherein
the image to be corrected is extracted by detecting an image having a shooting condition most matching a prescribed shooting condition of an image to which image quality correction of the most frequently used image quality correction item is made from among the images to be corrected.

8. The printing method according to claim 1, further comprising:
accepting an image to be printed from a client;
displaying the accepted image on a display device;
accepting a print order by selecting the displayed image on the display device;
detecting a RAW image from among images which are accepted from the client and are to be printed;
developing the detected RAW image in a developing process;
assigning a symbol identifying a RAW image; and
displaying the RAW image to which the symbol is assigned on the display device.

9. The printing method according to claim 2, further comprising:
accepting an image to be printed from a client;
displaying the accepted image on a display device;
accepting a print order by selecting the displayed image on the display device;
detecting a RAW image from among images which are accepted from the client and are to be printed;
developing the detected RAW image in a developing process;
assigning a symbol identifying a RAW image; and
displaying the RAW image to which the symbol is assigned on the display device.

10. The printing method according to claim 3, further comprising:
accepting an image to be printed from a client;
displaying the accepted image on a display device;
accepting a print order by selecting the displayed image on the display device;
detecting a RAW image from among images which are accepted from the client and are to be printed;
developing the detected RAW image in a developing process;
assigning a symbol identifying a RAW image; and
displaying the RAW image to which the symbol is assigned on the display device.

11. The printing method according to claim 8, wherein
when an image for which a client places a print order is a RAW image, the image is developed in a developing process, and then printed.

12. A printing system which makes image quality correction of an item indicated by a client to an image for which a print order is placed from a print acceptance terminal, and prints the image on a printer, comprising:
a management device which manages a print history of a client individually for each client;
a repeat print target image detection device which detects as an image to be repeat-printed based on the print history of an image for which an order for repeat print is placed in images for which print orders are accepted from the client; and
an image quality correction setting device which sets an item of image quality correction and an amount of correction based on the print history such that the same image quality correction as the image quality correction made before to the image to be repeat-printed detected by the repeat print target image detection device can be made.

13. The printing system according to claim 12, further comprising:
a most frequently used image quality correction item detection device which detects a most frequently used item of image quality correction in items of image quality correction made before by a client who places a print order as a most frequently used image quality correction item from the print history;
a correction target extraction device which extracts an image requiring image quality correction of the most frequently used image quality correction item detected by the most frequently used image quality correction item detection device as an image to be corrected from among images for which print orders are newly placed based on the print history;
a most correction requiring target image extraction device which extracts an image most requiring image quality correction as a target image most requiring correction from among extracted images to be corrected extracted by the correction target extraction device based on the print history;
a sample image generation device which generates a plurality of sample images by stepwise changing an amount of correction of the target image most requiring correction extracted by the most correction requiring target image extraction device and makes image quality correction to the most frequently used image quality correction item;
a display control device which displays the plurality of sample images generated by the sample image generation device on a display device; and
a selection device which selects one of the sample images displayed on the display device, wherein
the image quality correction setting device sets an item of image quality correction to be made to the image to be corrected and an amount of correction such that the same image quality correction as the image quality correction made to the sample image selected by the selection device can be made.

14. A printing system which makes image quality correction of an item indicated by a client to an image for which a print order is placed from a print acceptance terminal, and prints the image on a printer, comprising:
a management device which manages a print history of a client individually for each client;
a most frequently used image quality correction item detection device which detects a most frequently used item of image quality correction in items of image quality correction made before by a client who places a print order as a most frequently used image quality correction item from the print history;
a correction target extraction device which extracts an image requiring image quality correction of the most frequently used image quality correction item detected by the most frequently used image quality correction item detection device as an image to be corrected from among images for which print orders are newly placed based on the print history;
a most correction requiring target image extraction device which extracts an image most requiring image quality correction as a target image most requiring correction from among extracted images to be corrected by the correction target execution device based on the print history;
a sample image generation device which generates a plurality of sample images by stepwise changing an amount of correction of the target image most requiring correction extracted by the most correction requiring target image extraction device and makes image quality correction to the most frequently used image quality correction item;
a display control device which displays the plurality of sample images generated by the sample image generation device on a display device;
a selection device which selects one of the sample images displayed on the display device; and
an image quality correction setting device which sets an item of image quality correction to be made to the image to be corrected and an amount of correction such that the same image quality correction as the image quality correction made to the sample image selected by the selection device can be made.

15. The printing system according to claim 13, wherein
the correction target image extraction device extracts the image to be corrected by detecting an image having the same shooting condition as a prescribed shooting condition of an image to which image quality correction of the most frequently used image quality correction item is made from among images for which print orders are newly placed.

16. The printing system according to claim 14, wherein
the correction target image extraction device extracts the image to be corrected by detecting an image having the same shooting condition as a prescribed shooting condition of an image to which image quality correction of the most frequently used image quality correction item is made from among images for which print orders are newly placed.

17. The printing system according to claim 13, wherein
the most correction requiring target image extraction device extracts the image to be corrected by detecting an image having a shooting condition most matching a prescribed shooting condition of an image to which image quality correction of the most frequently used image quality correction item is made from among the images to be corrected.

18. The printing system according to claim 14, wherein
the most correction requiring target image extraction device extracts the image to be corrected by detecting an image having a shooting condition most matching a prescribed shooting condition of an image to which image quality correction of the most frequently used image quality correction item is made from among the images to be corrected.

19. The printing system according to claim 12, further comprising:
an accepting device which accepts an image to be printed from a client and makes the accepted image to be displayed on a display device;
a selection device which selects the displayed image displayed on the display device and places a print order;
a RAW image detection device which detects a RAW image from among images which are accepted from a client and are to be printed; and
a developing device which develops a RAW image, wherein
the RAW image detected by the RAW image detection device is developed by the developing device, assigned a symbol identifying a RAW image, and displayed on the display device.

20. The printing system according to claim 13, further comprising:
an accepting device which accepts an image to be printed from a client and makes the accepted image to be displayed on a display device;
a selection device which selects the displayed image displayed on the display device and places a print order;
a RAW image detection device which detects a RAW image from among images which are accepted from a client and are to be printed; and
a developing device which develops a RAW image, wherein
the RAW image detected by the RAW image detection device is developed by the developing device, assigned a symbol identifying a RAW image, and displayed on the display device.

21. The printing system according to claim 14, further comprising:
an accepting device which accepts an image to be printed from a client and makes the accepted image to be displayed on a display device;
a selection device which selects the displayed image displayed on the display device and places a print order;
a RAW image detection device which detects a RAW image from among images which are accepted from a client and are to be printed; and
a developing device which develops a RAW image, wherein
the RAW image detected by the RAW image detection device is developed by the developing device, assigned a symbol identifying a RAW image, and displayed on the display device.

22. The printing system according to claim 19, wherein
when an image for which a client places a print order is a RAW image, the developing device performs a developing process on the image, and then prints the image.

23. The printing system according to claim 12, wherein
each print acceptance terminal is connected such that the terminal can communicate with a management server, and the management server comprises the management device, and centrally manages the print history.

24. The printing system according to claim 13, wherein
each print acceptance terminal is connected such that the terminal can communicate with a management server, and the management server comprises the management device, and centrally manages the print history.

25. The printing system according to claim 14, wherein
each print acceptance terminal is connected such that the terminal can communicate with a management server, and the management server comprises the management device, and centrally manages the print history.
